(19) United States
(12) Patent Application Publication
(10) Pub. No.: US 2025/0077921 A1
(43) Pub. Date: Mar. 6, 2025

(54) CLIFFORD UNITARY SYNTHESIS VIA GENERALIZED S AND CZ GATES

(71) Applicant: Microsoft Technology Licensing, LLC, Redmond, WA (US)

(72) Inventor: Vadym KLIUCHNIKOV, Ontario (CA)

(21) Appl. No.: 18/239,264

(22) Filed: Aug. 29, 2023

(51) Int. Cl. G06N 10/20; G06F 17/16

(52) U.S. Cl. CPC G06N 10/20; G06F 17/16

(57) ABSTRACT

Aspects of the disclosure include decomposing a matrix for a Clifford unitary into a product of first and second involution matrices, determining first symplectic matrix that transforms first involution matrix into a first matrix, a first Clifford unitary matrix being described by first symplectic matrix, and determining second symplectic matrix that transforms second involution matrix into second matrix, a second Clifford unitary matrix being described by second symplectic matrix. Aspects include, responsive to first matrix being a diagonal matrix, setting a second number to size of first matrix and setting a second sequence to include the second number of generalized S gates, and responsive to second matrix being a diagonal matrix, setting a first number to size of second matrix and setting a first sequence to include the first number of generalized S gates. Aspects include executing first sequence, second sequence, and a Pauli unitary P on the quantum computer.

### INTRODUCTION

The subject disclosure relates to quantum circuits, and particularly to Clifford unitary synthesis via generalized phase (S) gates and controlled-Z (CZ) gates.

A quantum computer is a physical machine configured to execute logical operations based on or influenced by quantum-mechanical phenomena. Such logical operations may include, for example, mathematical computation. Where conventional computer memory holds digital data in an array of bits and enacts bitwise logical operations, a quantum computer holds data in an array of qubits and operates quantum mechanically on the qubits in order to implement the desired logic. One or more quantum logic gates may thus be applied to operate on a set of qubits. Current interest in quantum-computer technology is motivated by analysis suggesting that the computational efficiency of an appropriately configured quantum computer may surpass that of any practicable non-quantum computer when applied to certain types of problems. Such problems include computer modeling of natural and synthetic quantum systems, integer factorization, data searching, and function optimization as applied to systems of linear equations and machine learning. Furthermore, it has been predicted that continued miniaturization of conventional computer logic structures will ultimately lead to the development of nanoscale logic components that exhibit quantum effects and should therefore be addressed according to quantum-computing principles.

Different types of quantum computers base their operation on different quantum-mechanical phenomena. A ‘topological’ quantum computer is a quantum computer whose operation is based on a non-Abelian topological phase of matter that may support ‘braidable’ quasiparticles. This type of quantum computer is expected to be less prone to the issue of quantum decoherence than other types of quantum computers, and may therefore serve as a relatively fault-tolerant quantum-computing platform.

### SUMMARY

Embodiments of the present invention are directed to methods for providing Clifford unitary synthesis via generalized S and CZ gates. A non-limiting example method for operating a quantum computer includes decomposing a matrix into a product of a first involution matrix and a second involution matrix, the matrix corresponding to an n-qubit Clifford unitary. The method includes determining a first symplectic matrix that transforms the first involution matrix into a first form aligned to a first form matrix, where a first Clifford unitary matrix is described by the first symplectic matrix. The method includes determining a second symplectic matrix that transforms the second involution matrix into a second form aligned to a second form matrix, where a second Clifford unitary matrix is described by the second symplectic matrix. The method includes, in response to the first form matrix being a diagonal matrix, setting a second k number to a first size of the first form matrix and setting a second sequence to include the second k number of S gates, where the second k number is less than or equal to a number n. The method includes, in response to the second form matrix being a diagonal matrix, setting a first k number to a second size of the second form matrix and setting a first sequence to include the first k number of S gates, where the first k number is less than or equal to the number n. Also, the method includes adding a Pauli unitary P subsequent to the first sequence and the second sequence, and causing execution of the first sequence, the second sequence, and the Pauli unitary P on the quantum computer.

Embodiments of the present invention are directed to methods for providing Clifford unitary synthesis via generalized S and CZ gates. A non-limiting example method for operating a quantum computer includes decomposing a matrix into a product of a first involution matrix and a second involution matrix, the matrix corresponding to an n-qubit Clifford unitary. The method includes determining a first symplectic matrix that transforms the first involution matrix into a first form aligned to a first form matrix, where a first Clifford unitary matrix is described by the first symplectic matrix. The method includes determining a second symplectic matrix that transforms the second involution matrix into a second form aligned to a second form matrix wherein a second Clifford unitary matrix is described by the second symplectic matrix. The method includes, in response to the first form matrix failing to be a diagonal matrix, setting a second k number to half a first size of the first form matrix and setting a second sequence to include the second k number of CZ gates, wherein the second k number is about half a number n. The method includes, in response to the second form matrix being a diagonal matrix, setting a first k number to a second size of the second form matrix and setting a first sequence to include the first k number of S gates, where the first k number is less than or equal to the number n. Also, the method includes adding a Pauli unitary P subsequent to the first sequence and the second sequence, and causing execution of the first sequence, the second sequence, and the Pauli unitary P on the quantum computer.

Embodiments of the present invention are directed to methods for providing Clifford unitary synthesis via generalized S and CZ gates. A non-limiting example method for operating a quantum computer includes decomposing a matrix into a product of a first involution matrix and a second involution matrix, the matrix corresponding to an n-qubit Clifford unitary. The method includes determining a first symplectic matrix that transforms the first involution matrix into a first form aligned to a first form matrix, where a first Clifford unitary matrix is described by the first symplectic matrix. The method includes determining a second symplectic matrix that transforms the second involution matrix into a second form aligned to a second form matrix wherein a second Clifford unitary matrix is described by the second symplectic matrix. The method includes, in response to the first form matrix meeting a condition related to a diagonal matrix, setting a second k number to a first size of the first form matrix and setting the second sequence to include the second k number of second gates, wherein the second k number is related to a number n. The method includes, in response to the second form matrix not being the diagonal matrix, setting a first k number to half a second size of the second form matrix and setting a first sequence to include the first k number of CZ gates, where the first k number is half the number n. The method includes adding a Pauli unitary P subsequent to the first sequence and the second sequence, and causing execution of the first sequence, the second sequence, and the Pauli P on the quantum computer.

The above features and advantages, and other features and advantages of the disclosure are readily apparent from the following detailed description when taken in connection with the accompanying drawings. This Summary is provided to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any or all disadvantages noted in any part of this disclosure.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an example quantum computer configured to execute quantum-logic operations in accordance with one or more embodiments;

FIG. 2 depicts an illustration of a Bloch sphere that provides a graphical description of some quantum mechanical aspects of an individual qubit in accordance with one or more embodiments;

FIG. 3 is a graph of example signal levels associated durations to assert a quantum-gate operation on one or more qubits of a quantum circuit in accordance with one or more embodiments;

FIG. 4 depicts a layout of a quantum circuit in accordance with one or more embodiments;

FIG. 5A depicts a vertical brick wall unit of a honeycomb lattice in accordance with one or more embodiments;

FIG. 5B depicts a vertical brick wall unit of the 4.8.8 lattice in accordance with one or more embodiments;

FIG. 5C depicts the directions for XX, YY, and ZZ measurements in accordance with one or more embodiments;

FIG. 5D depicts example bulk YY measurements in accordance with one or more embodiments;

FIG. 5E depicts example bulk XX measurements in accordance with one or more embodiments;

FIG. 5F depicts example bulk ZZ measurements in accordance with one or more embodiments;

FIG. 6 depicts examples of quantum circuit notation for computations using logical qubits that are formed by one or more physical qubits in accordance with one or more embodiments;

FIG. 7A depicts remote execution of an S gate in accordance with one or more embodiments;

FIG. 7B depicts remote execution of an S gate in accordance with one or more embodiments;

FIG. 8A depicts remote execution of a CZ gate in accordance with one or more embodiments;

FIG. 8B depicts remote execution of a CZ gate in accordance with one or more embodiments;

FIG. 9A depicts a circuit for executing a Clifford S gate using one Pauli measurement in accordance with one or more embodiments;

FIG. 9B depicts a circuit for executing a Clifford CZ gate using two multi-qubit Pauli measurements in accordance with one or more embodiments;

FIG. 10 illustrates Table 1 having formulas for estimating the physical qubit and time overheads required to implement logical qubits with the surface code and the Hastings-Haah code as a function of qubit design parameters in accordance with one or more embodiments;

FIG. 11A depicts patches of physical qubits encoding logical qubits in either the surface code or the Hastings-Haah code in accordance with one or more embodiments;

FIG. 11B depicts one-tile patches and two-tile patches, which encode one and two qubits into physical qubits in accordance with one or more embodiments;

FIG. 11C depicts Hadamard and phase unitaries that can be applied to a qubit in a one-tile patch with an adjacent ancilla tile in accordance with one or more embodiments;

FIG. 11D depicts a move of a qubit in a one-tile patch to a different tile along a path connecting any boundaries of the starting and ending tiles in accordance with one or more embodiments;

FIG. 11E depicts a non-destructive multi-qubit X, Z type measurement of the qubits in a set of one-tile patches in accordance with one or more embodiments;

FIG. 11F depicts a non-destructive multi-qubit arbitrary Pauli measurement of a set of qubits stored in two-tile patches in accordance with one or more embodiments;

FIG. 11G depicts T state preparation in either a one-tile patch or a two-tile patch in accordance with one or more embodiments;

FIG. 12 depicts an example sequence of a series of S gates in accordance with one or more embodiments;

FIG. 13 depicts an example sequence of a series of S gates in accordance with one or more embodiments;

FIG. 14 depicts an example sequence of a series of S gates in accordance with one or more embodiments;

FIG. 15 depicts an example first sequence of S gates, a second sequence of CZ gates, and a Pauli unitary P for execution by a quantum computer in accordance with one or more embodiments;

FIG. 16 is a flowchart of a computer-implemented method for operating a quantum computer, by performing Clifford unitary synthesis via generalized S gates and CZ gates to execute a Clifford unitary on the quantum computer in accordance with one or more embodiments;

FIG. 17 is a flowchart of a computer-implemented method for operating a quantum computer, by performing Clifford unitary synthesis via generalized S gates and CZ gates to execute a Clifford unitary on the quantum computer in accordance with one or more embodiments;

FIG. 18 is a flowchart of a computer-implemented method for operating a quantum computer, by performing Clifford unitary synthesis via generalized S gates and CZ gates to execute a Clifford unitary on the quantum computer in accordance with one or more embodiments; and

FIG. 19 depicts a block diagram of a classical computer system according to one or more embodiments.

The diagrams depicted herein are illustrative. There can be many variations to the diagram or the operations described therein without departing from the spirit of the invention. For instance, the actions can be performed in a differing order or actions can be added, deleted or modified.

In the accompanying figures and following detailed description of the described embodiments of the invention, the various elements illustrated in the figures are provided with two or three-digit reference numbers. With minor exceptions, the leftmost digit(s) of each reference number corresponds to the figure in which its element is first illustrated.

### DETAILED DESCRIPTION

In accordance with one or more embodiments, a system, method, and/or computer are configured and arranged to provide Clifford unitary synthesis via generalized phase (S) gates and controlled-Z (CZ) gates. One or more embodiments disclose that any n-qubit Clifford unitary can be implemented using at most 2n multi-qubit joint measurements, where n refers to the number of logical qubits to which one applies the Clifford unitary C. The n number of logical qubits utilized for the Clifford unitary C can be a predetermined subset or arbitrary subset of all logical qubits in a fault-tolerant quantum computer. In one or more embodiments, all the multi-qubit joint measurements used for implementing the Clifford unitary C can be chosen to form at most two sets of independent mutually-commuting measurements. Each of these sets is of a size at most n. This is useful when seeking to implement an arbitrary n-qubit Clifford unitary using lattice-surgery surface codes. An issue may naturally arise when switching between different layout methods for mapping a quantum algorithm to fault-tolerant hardware of a quantum computer, for example, when switching from Pauli-Based Computation or Parallel Synthesis Sequential Pauli Computation layout methods to any other layout methods, such as Edge Disjoint Paths. In accordance with one or more embodiments, having two sets of mutually-commuting joint measurements enable more flexibility for space-time trade-offs.

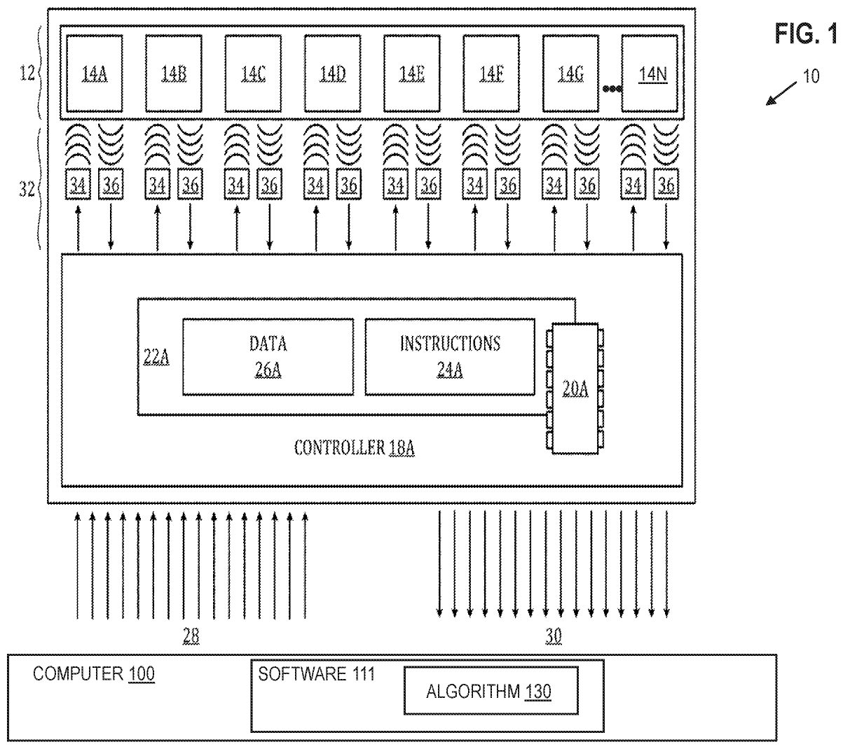

In quantum computing and quantum information theory, the Clifford gates are the elements of the Clifford group, which a set of mathematical transformations that normalize the n-qubit Pauli group, i.e., map tensor products of Pauli matrices to tensor products of Pauli matrices through conjugation. Logical operations can be expressed in a software program on a classical computer and an instruction-set architecture (another software program) can translate the logical operations into measurements/operations that can be performed on the physical qubits of a quantum computer. When switching from one layout method to another layout method, the Clifford unitary is to be executed on n qubits. The Clifford unitary is a unitary that involves all the data on the quantum computer that is useful for the algorithm or problem being solved. One or more embodiments provide a method for executing the Clifford unitary, which can be expressed as a Clifford synthesis algorithm 130 discussed further in FIG. 1.

It is noted that quantum computing can utilize methods that suppress errors in faulty qubits. Quantum error correction (QEC) is a broad class of techniques that encode “logical” qubits and gates in a subspace of the Hilbert space formed by many more “physical” qubits and gates. The structure of a quantum code has an influence on how logical gates are enacted on the physical qubits, and hence the total size and execution time of a quantum computation.

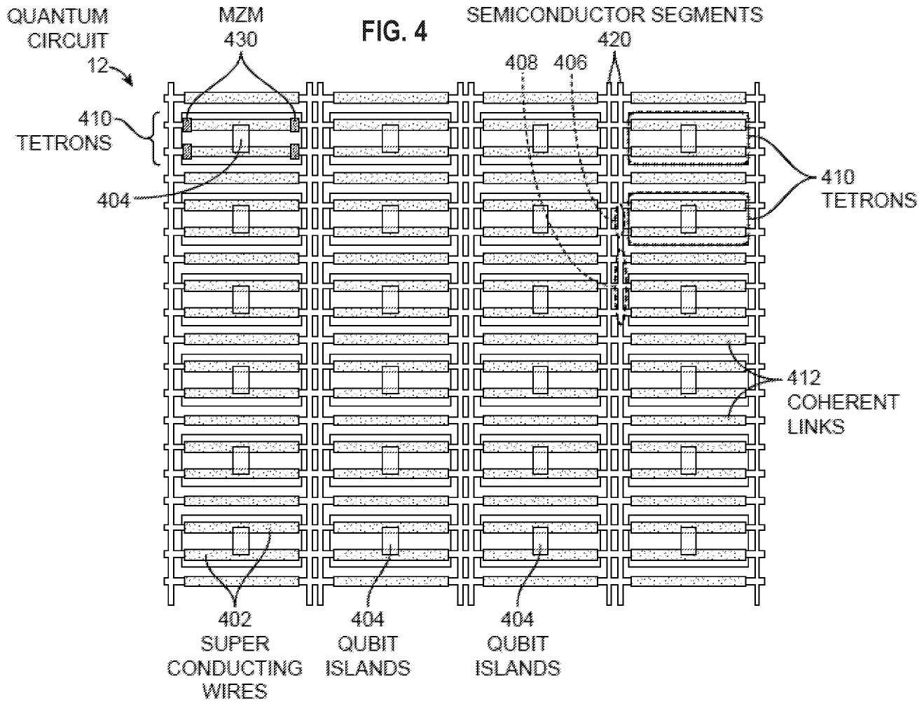

Example Quantum Computer Architecture: FIG. 1 illustrates an example quantum computer 10 configured to execute quantum-logic operations. Whereas conventional computer memory holds digital data in an array of bits and enacts bit-wise logic operations, a quantum computer holds data in an array of qubits and operates quantum-mechanically on the qubits in order to implement the desired logic. Accordingly, quantum computer 10 of FIG. 1 includes at least one quantum circuit 12 having an array of physical qubits 14A, 14B, 14C-14N, where N is the last number of qubits. The qubits 14A-14N can be referred to collectively as qubits 14. The quantum circuit 12 of the array of qubits 14 can be arranged in a lattice structure as depicted in FIG. 4.

The qubits 14 of the quantum circuit 12 take various forms, depending on the desired architecture of quantum computer 10. While this disclosure relates to qubits embodied as quasiparticles in a non-Abelian topological phase, a qubit alternatively can include: a superconducting Josephson junction, a trapped ion, a trapped atom coupled to a high-finesse cavity, an atom or molecule confined within a fullerene, an ion or neutral dopant atom confined within a host lattice, a quantum dot exhibiting discrete spatial- or spin-electronic states, electron holes in semiconductor junctions entrained via an electrostatic trap, a coupled quantum-wire pair, an atomic nucleus addressable by magnetic resonance, a free electron in helium, a molecular magnet, or a metal-like carbon nanosphere, as non-limiting examples. More generally, each qubit 14 can include any particle or system of particles that can exist in two or more discrete quantum states that can be measured and manipulated experimentally. For instance, a qubit may be implemented in the plural processing states corresponding to different modes of light propagation through linear optical elements (e.g., mirrors, beam splitters and phase shifters), as well as in states accumulated within a Bose-Einstein condensate.

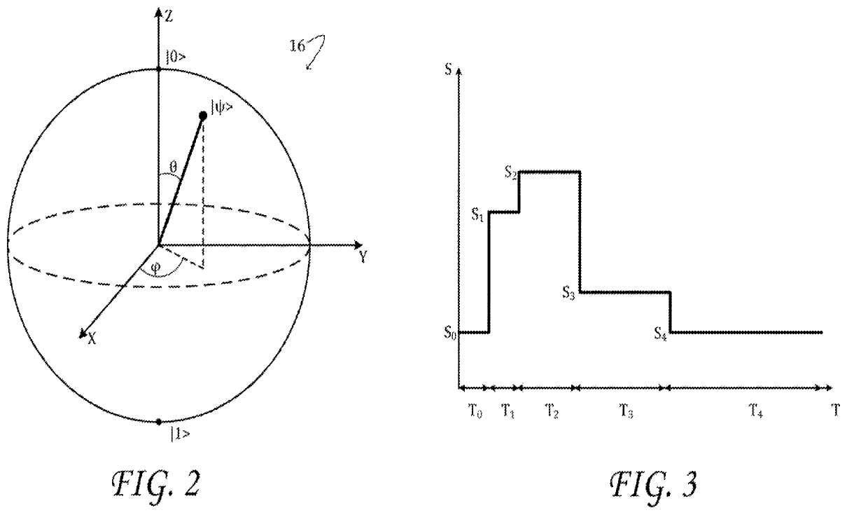

FIG. 2 is an illustration of a Bloch sphere 16, which provides a graphical description of some quantum mechanical aspects of an individual qubit 14. In this description, the north and south poles of the Bloch sphere correspond to the standard basis vectors |0> and |1>, respectively. The set of points on the surface of the Bloch sphere comprise all possible pure states |ψ> of the qubit, while the interior points correspond to all possible mixed states. A mixed state of a given qubit may result from decoherence, which may occur because of undesirable coupling to external degrees of freedom.

Referring to FIG. 1, quantum computer 10 includes a controller 18A. The controller 18A includes at least one processor 20A and associated computer memory 22A. The processor 20A of the controller 18A can be coupled operatively to peripheral componentry, such as network componentry, to enable the quantum computer to be operated remotely. The processor 20A of the controller 18A can take the form of a central processing unit (CPU), a graphics processing unit (GPU), or the like. As such, the controller can include classical electronic componentry. The terms ‘classical’ and ‘non-quantum’ are applied herein to any component that can be modeled accurately as an ensemble of particles without considering the quantum state of any individual particle. Classical electronic components include integrated, microlithographed transistors, resistors, and capacitors, for example. The computer memory 22A can be configured to hold program instructions 24A that cause the processor 20A to execute any function or process of the controller. The computer memory can also be configured to hold additional data 26A. In examples in which quantum circuit 12 is a low-temperature or cryogenic device, the controller 18A can include control componentry operable at low or cryogenic temperatures, for example, a field-programmable gate array (FPGA) operated at 77 kelvin (K). In such examples, the low-temperature control componentry can be coupled operatively to interface componentry operable at normal temperatures.

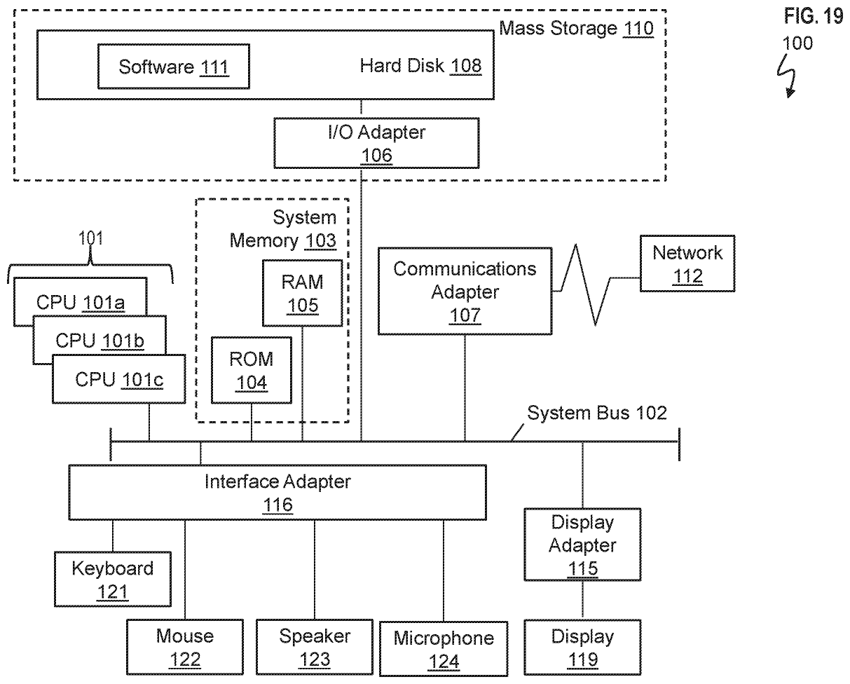

The controller 18A of the quantum computer 10 is configured to receive a plurality of inputs 28 and to provide a plurality of outputs 30. The inputs and outputs can each include digital and/or analog lines. At least some of the inputs and outputs can be data lines through which data is provided to and/or extracted from the quantum computer. Other inputs can include control lines via which the operation of the quantum computer can be adjusted or otherwise controlled. In one or more embodiments, the quantum computer 10 can be coupled a classical computer 100. Further, details of the example classical computer 100 are discussed in FIG. 19.

The controller 18A is operatively coupled to the quantum circuit 12 via quantum interface 32. The quantum interface 32 is configured to exchange data bidirectionally with the controller 18A. The quantum interface 32 is further configured to exchange signal corresponding to the data bidirectionally with the qubit register. Depending on the architecture of quantum computer 10, such signal may include electrical, magnetic, and/or optical signal. By the signal conveyed through the quantum interface 32, the controller 18A can interrogate and otherwise influence the quantum state held in various qubits 14. For example, the controller 18A can interrogate and otherwise influence the quantum state held a qubit register, as defined by a collective quantum state of a group of qubits 14. The quantum interface 32 includes at least one modulator 34 and at least one demodulator 36, each coupled operatively to one or more qubits 14 of the quantum circuit 12. In one or more embodiments, a modulator 34 and a demodulator 36 can each be coupled to qubits in a qubit register. Each modulator 34 is configured to output a signal to one or more qubits 14 in the quantum circuit 12 based on modulation data received from the controller 18A. In one or more embodiments, at least one modulator 34 can output a signal to qubits in a qubit register based on modulation data received from the controller 18A. Each demodulator 36 is configured to sense a signal from the one or more qubits 14 of the quantum circuit 12 and to output data to the controller 18A based on the signal. In one or more embodiments, each demodulator 36 is configured to sense a signal from the qubit register and to output data to the controller 18A based on the signal. The data received from the demodulator 36 can, in some examples, be an estimate of an observable to the measurement of the quantum state held in one or more qubits 14 in the quantum circuit 12. In one or more embodiments, the data received from the demodulator 36 can be an estimate of an observable to the measurement of the quantum state held in the qubit register.

In some examples, the modulator 34 can transmit a suitably configured signal to interact physically with one or more qubits 14 of the quantum circuit 12 in order to trigger measurement of the quantum state held in one or more qubits 14. The demodulator 36 can then sense a resulting signal released by the one or more qubits 14 pursuant to the measurement and can provide the data corresponding to the resulting signal to the controller 18A. Stated another way, the demodulator 26 is configured to output, based on the signal received, an estimate of one or more observables reflecting the quantum state of one or more qubits of the qubit register, and to furnish the estimate to the controller 18A. In one non-limiting example, the modulator 34 can provide, based on data from the controller 18A, an appropriate voltage pulse or pulse train to an electrode of one or more qubits 14, to initiate a measurement. In short order, the demodulator 36 can sense photon emission from the one or more qubits 14 and can assert a corresponding digital voltage level on a quantum-interface line into the controller 18A. Generally speaking, any measurement of a quantum-mechanical state is defined by the operator “O” corresponding to the observable to be measured; the result “R” of the measurement is guaranteed to be one of the allowed eigenvalues of “O”. In the quantum computer 10, “R” is statistically related to the qubit-register state prior to the measurement but is not uniquely determined by the qubit-register state.

Pursuant to appropriate input from the controller 18A, the quantum interface 32 may be configured to implement one or more quantum-logic gates to operate on the quantum state held in the quantum circuit 12, for example, in a qubit register in the quantum circuit 12. Whereas the function of each type of logic gate of a classical computer system is described according to a corresponding truth table, the function of each type of quantum gate is described by a corresponding operator matrix. The operator matrix operates on (i.e., multiplies) the complex vector representing the qubit register state and effects a specified rotation of that vector in Hilbert space.

For example, the Hadamard gate HAD is defined by

$$HAD = \frac{1}{\sqrt{2}} [ \begin{matrix}1 & 1 \\ 1 & - 1\end{matrix} ] . \qquad ( A )$$

The HAD gate acts on a single qubit; it maps the basis state

$$\vert 0 〉 to \frac{( \vert 0 〉 )}{\sqrt{2}} ,$$

and maps to |1> to (|0>−|1>)\sqrt{2}. Accordingly, the HAD gate creates a superposition of states that, when measured, have equal probability of revealing |0> or |1>.

The phase gate S is defined by

$$S = [ \begin{matrix}1 & 0 \\ 0 & {e}^{\frac{i π}{2}}\end{matrix} ] . \qquad ( B )$$

The S gate leaves the basis state |0> unchanged but maps |1> to e^{iπ/2}|1>. Accordingly, the probability of measuring either |0> or |1> is unchanged by this gate, but the phase of the quantum state of the qubit is shifted. This is equivalent to rotating ψ by 90 degrees along a circle of latitude on the Bloch sphere of FIG. 2.

Some quantum gates operate on two or more qubits. The SWAP gate, for example, acts on two distinct qubits and swaps their values. This gate is defined by

$$SWAP = [ \begin{matrix}1000 \\ 1010 \\ 0100 \\ 0001\end{matrix} ] . \qquad ( C )$$

The foregoing list of quantum gates and associated operator matrices is non-exhaustive but is provided for ease of illustration. Other quantum gates include Pauli-X, -Y, and -Z gates, the \sqrt{NOT} gate, additional phase-shift gates, the \sqrt{SWAP} gate, controlled cX, cY, and cZ gates, and the Toffoli, Fredkin, Ising, and Deutsch gates, as non-limiting examples.

Continuing in FIG. 1, suitably configured signal from modulators 34 of the quantum interface 32 can interact physically with one or more qubits 14 of the quantum circuit 12, for example, a qubit register in the quantum circuit 12, so as to assert any desired quantum-gate operation. As noted above, the desired quantum-gate operations are specifically defined rotations of a complex vector representing the qubit register state. In order to effect a desired rotation “O”, one or more modulators of quantum interface 32 can apply a predetermined signal level Sᵢ for a predetermined duration Tᵢ. In some examples, plural signal levels can be applied for plural sequenced or otherwise associated durations, as depicted in FIG. 3, to assert a quantum-gate operation on one or more qubits of the quantum circuit 12, for example, in a qubit register of the quantum circuit 12. In general, each signal level Sᵢ and each duration Tᵢ is a control parameter adjustable by appropriate programming of controller 18A.

The term ‘oracle’ is used herein to describe a predetermined sequence of elementary quantum-gate and/or measurement operations executable by quantum computer 10. An oracle can be used to transform the quantum state of qubits 14 in the quantum circuit 12, for example, qubits in a qubit register, to effect a classical or non-elementary quantum-gate operation or to apply a density operator, for example. In some examples, an oracle may be used to enact a predefined ‘black-box’ operation f(x), which may be incorporated in a complex sequence of operations. To ensure adjoint operation, an oracle mapping n input qubits |x> to m output or ancilla qubits |y>f(x) may be defined as a quantum gate O(|x>⊗|y>) operating on the n+m qubits. In this case, O can be configured to pass the n input qubits unchanged but combine the result of the operation f(x) with the ancillary qubits via an XOR operation, such that O(|x>⊗t>)=x>⊗|y+f(x)>. As described further below, a state-preparation oracle is an oracle configured to generate a quantum state of specified qubit length.

Implicit in the description herein is that each qubit 14 of qubit registers can be interrogated via quantum interface 32 so as to reveal with confidence the standard basis vector |0> or |1> that characterizes the quantum state of that qubit. In some implementations, however, measurement of the quantum state of a physical qubit could be subject to error. Accordingly, any physical qubit 14 can be implemented as a logical qubit, which includes a grouping of physical qubits measured according to an error-correcting oracle that reveals the quantum state of the logical qubit with confidence.

Topological Quantum Computer: In a topological quantum computer, the quantum state held in each qubit is a state of two or more braidable quasiparticles, or ‘anyons’, observed within a non-Abelian topological phase of matter. The world lines of different anyons are quantum mechanically forbidden from intersecting or merging. This feature forces their paths to form stable braids that pass around each other in space-time. Relative to trapped particles used in other types of quantum computers, anyon braids are more resistant to quantum decoherence, which is a source of error in quantum computation. However, the realization of a topological quantum computer has the ability to engineer a suitable topological phase and to manipulate the anyons therein.

Early experiments in topological quantum computing focused on the two-dimensional ‘electron gas’ of a supercooled, thin layer of gallium arsenide (GaAs) sandwiched between layers of aluminum gallium arsenide (AlGaAs) and manipulated in a strong magnetic field. Implementation of a quantum computer using that architecture includes the braiding of individual quasiparticle excitations combined with anyonic interferometry-based measurement, involving coherent quasiparticle transport over significant distances.

Proposed more recently is a one-dimensional topological qubit architecture that is more amenable to practical implementation. The proposed system uses a semiconductor-superconductor heterostructure wherein superconductivity, strong spin-orbit coupling, and magnetic fields cooperate to form a topological, superconducting state that supports Majorana zero modes (MZMs). This architecture obviates the need to move quasiparticles by employing a ‘measurement-only’ method wherein a sequence of measurements has the same effect as a braiding operation. This architecture does not require quasiparticles to be moved through an interferometry loop, but rather exploits a distinction between a ‘fermion parity-protected topological phase’ (the actual genus of the proposed heterostructure) and a true topological phase. Advantageously, topological charge in a fermion parity-protected topological phase can be manipulated by the process of electron tunneling into an MZM. Transport through a pair of MZMs can provide a measurement of their combined topological charge in the presence of a large charging energy.

In view of these and other useful properties, MZMs can be used as a basis for the qubits of a topological quantum computer. The MZMs are created at the ends of semiconductor-superconductor heterostructures tuned into a topological regime by the appropriate magnetic field and gate voltages. A series of practical implementations are described in Karzig et al., Scalable Designs for Quasiparticle-Poisoning-Protected Topological Quantum Computation with Majorana Zero Modes, arXiv:1610.05289v4 [cond-mat.mes-hall]21 Jun. 2017. Suitable heterostructure materials and material properties are described in Lutchyn et al., Majorana Fermions and a Topological Phase Transition in Semiconductor-Superconductor Heterostructures, arXiv:1002.4033v2 [cond-mat.supr-con]13 Aug. 2010. The entirety of both of the above references is hereby incorporated by reference herein, for all purposes.

Example implementations include at least two topological superconducting segments in a qubit, totaling at least four Majorana zero modes per qubit. The states used for quantum computation is the degenerate ground states of the qubit, in contrast to non-degenerate quantum-computing architectures where the two states of the qubit have different energies. The degeneracy of the qubit states and the spatial separation of the Majorana zero modes ensure long coherence times and feasibility of precise application of a set of Clifford gates.

FIG. 4 illustrates an example layout of a square lattice of tetrons used to implement a honeycomb and 4.8.8 Floquet codes. In FIG. 4, topological superconducting wires 402 have a MZM at both ends. Qubit islands 404 correspond to two parallel topological superconducting wires 402 joined by a trivial superconducting backbone, with MZMs 430 labeled according to the box in the upper left. MZMs 430 are illustrated for a single tetron 410 but applies to all of the tetrons 410. Rows of tetrons 410 are separated by coherent links 412, which are floating topological wires. Neighboring qubit islands 404 are connected by semiconducting segments 420, with two semiconducting columns of semiconducting segments 420 separating each column of qubit islands 404. There are also rows of semiconductor regions connected the semiconductor segments 420 to coherent links 412 and superconducting wire 402. The coherent links 412 do not have the qubit islands 404. The superconducting wires 402 connect to qubit islands 404, which are the physical qubits 14 in the quantum circuit 12. Since the physical qubits 14 are arranged in an array, the qubit islands 404 are in columns. A semiconductor segment 406 can be referred to as length-1 semiconductor quantum dot with gate defined. A semiconductor segment 408 can be referred to as length-2 semiconductor quantum dot with gate defined.

Each tetron 410 in FIG. 4 includes a physical qubit, where the qubit islands 404 are the physical qubits 14. The tetron 410, which encompasses a qubit island 404, can be referred to as a physical qubit. In the example square lattice as at least a portion of the quantum circuit 12, there is an array of 6*4=24 tetrons displayed, each representing a physical qubit. As seen in FIG. 4, the MZM 430 appears at the end of each topological superconducting wire 402. A quartet of MZMs 430 forms a logical qubit, where each tetron 410 has two topological superconducting wires 402, and each wire has two MZMs 430. All together each tetron 410 has 4 MZMs which includes one physical qubit, for example, physical quit 14.

Physical qubits are transformed into logical qubits using a fault tolerant protocol. The fault tolerant protocol provides a transformation such that algorithms of a classical computer can be applied to the quantum computer. The physical operations applied to physical qubits is in accordance with the logical operations applied to the logical qubits. The pattern of operations applied to the physical qubits is directly related to the logical operations for the logical qubits.

An example discussion of quantum error correction (QEC) and a planar quantum instruction-set architecture (ISA) is provided. Further description of quantum error correction and a planar quantum instruction-set architecture is described in Assessing requirements to scale to practical quantum advantage, by M. E. Beverland et al., arXiv:2211.07629 [quant-ph]14 Nov. 2022, which is incorporated by reference. A review of two QEC schemes is provided, focusing on estimates of the resources required for their implementation and for applying fault-tolerant logical operations on the encoded information. For qubits with a gate-based instruction set, surface code is assumed to be utilized. It is the best-understood QEC scheme for this class of qubits and offers a high threshold for practical implementation. For qubits with a Majorana instruction set, both the surface code and also the Hastings-Haah code are considered, which is a recently developed QEC scheme that offers better space-time costs than surface codes on Majorana qubits in many regimes. It is also possible to implement the Hastings-Haah code with qubits that use a gate-based instruction set.

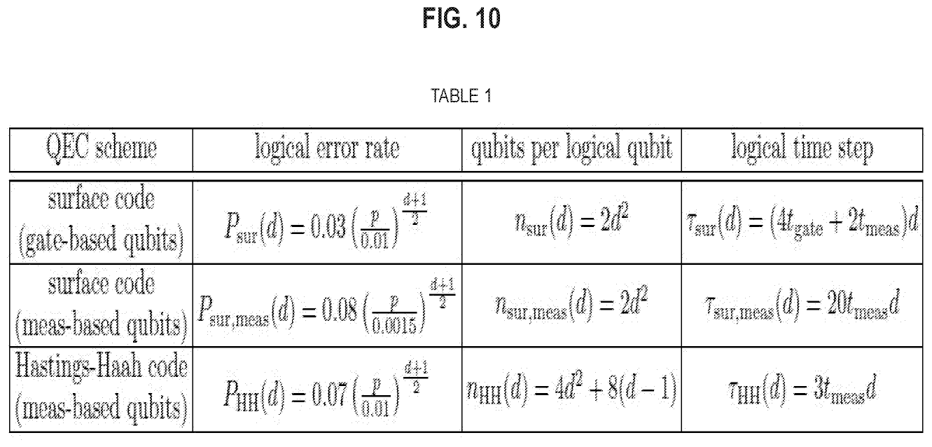

In Table 1 of FIG. 10, formulas are provided to estimate the physical qubit and time overheads required to implement logical qubits with the surface code and the Hastings-Haah code as a function of qubit design parameters. It is estimated that the logical error rate P(d) of a patch of surface code or Hastings-Haah code of distance d with physical error rate p using the formula

$$P ( d ) = a {( \frac{p}{p *} )}^{\frac{d + 1}{2}} ,$$

where the pre-factor a and threshold value p* can be extracted numerically from simulations.

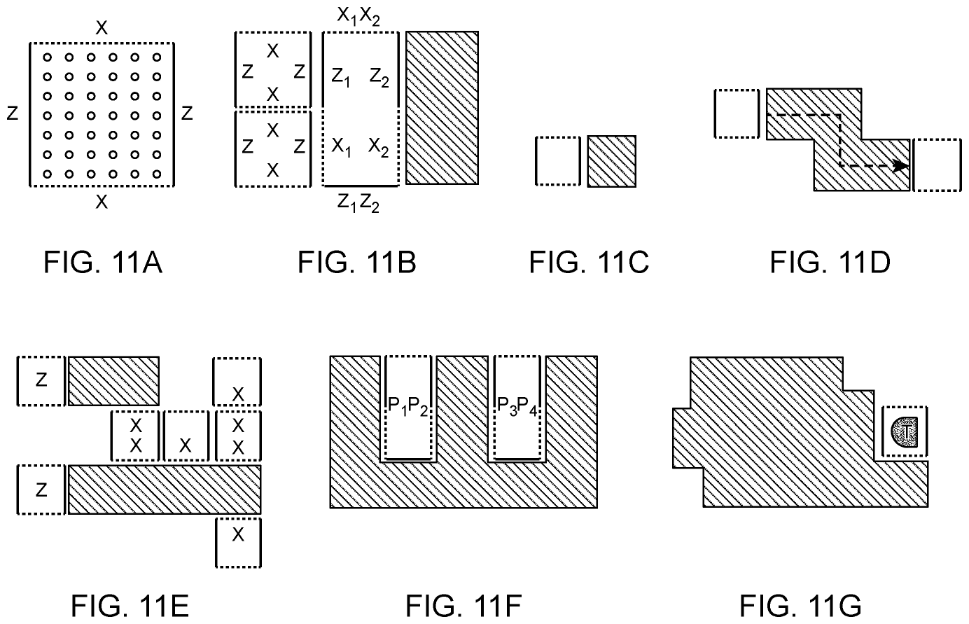

Protected logical operations can be applied to logical qubits stored in the surface code or the Hastings-Haah code. One can assume precisely the same types of logical patches, set of logical operations, and costs (in units of number of tiles and logical time steps) for surface codes and Hastings-Haah codes, which form the logical instruction set that is called the planar quantum instruction-set architecture (ISA) shown in FIGS. 11A, 11B, 11C, 11D, 11E, 11F, and 11G. As an example, the differences accounted for between two QEC codes are captured by the different formulas for the logical error rate P(d), number n(d) of physical qubits in a tile, and the time τ(d) for a logical time step for a given distance d, as specified in Table 1 of FIG. 10. The logical operations can be inexpensive, almost perfect and instantaneous (Pauli unitaries, single-qubit preparations and measurements), medium cost, requiring ancilla tiles and one logical time step (multi-qubit Pauli measurements), or expensive, such as T state preparation for the execution of so-called non-Clifford gates, which requires a significant number of time steps and auxiliary qubits. There are patch choices and logical Clifford operations and costs.

Turning to FIGS. 11A, 11B, 11C, 11D, 11E, 11F, and 11G as examples, depicted are fault-tolerant logical operations as an instruction set of the planar quantum ISA. FIG. 11A illustrates that patches of physical qubits encode logical qubits in either the surface code or the Hastings-Haah code, with error correction performed using operations from the instruction set. The array of physical qubits is grouped into tiles, each containing n(d) physical qubits and count logical operations in units of logical time steps τ(d) as predefined. FIG. 11B depicts a focus on one-tile patches and two-tile patches, which encode one and two qubits into n(d) and 2n(d) physical qubits respectively. Sections are labeled for the boundary of these patches, which are relevant for the logical operations of the planar quantum ISA. Preparation of qubits in one-tile and two-tile patches in computational basis states can be applied in 0τ(d). Arbitrary Pauli unitaries can be applied to qubits in one-tile and two-tile patches in 0τ(d). Destructive measurement of a qubit in a one-tile patch in the X or Z basis and of both of the qubits in a two-tile patch (either both in the X basis or both in the Z basis) can be done in 0τ(d). FIG. 11C depicts that Hadamard and phase unitaries can be applied to a qubit in a one-tile patch with an adjacent ancilla tile in 3τ(d) and 3τ(d) respectively. The ancilla can be on any boundary for the Hadamard, and next to a Z boundary for the phase. FIG. 11D depicts a move of a qubit in a one-tile patch to a different tile along a path connecting any boundaries of the starting and ending tiles in 1τ(d). FIG. 11E depicts a non-destructive multi-qubit X, Z type measurement of the qubits in a set of one-tile patches that can be implemented in 1τ(d). This can be done by forming a connected region of tiles, where each tile hosting a qubit to be measured in the X (Z) basis connects through one or both of its X (Z) boundaries, and connections can be between adjacent qubit tiles, or mediated by ancilla tiles. FIG. 11F depicts a non-destructive multi-qubit arbitrary Pauli measurement of a set of qubits stored in two-tile patches can be performed in 1τ(d). This can be achieved with a connected region of ancilla tiles with access to all of the X and Z boundaries of each of the two-tile patches. FIG. 11G depicts T state preparation in either a one-tile patch or a two-tile patch can be achieved using a distillation factory, using a non-integer number of tiles and logical time steps which depends on the quality requirements of the state.

As an example, the Hastings-Haah code is measurement code for logical qubits, and the measurements can be performed using plaquettes. The Hastings-Haah code is based on a honeycomb lattice. As noted herein, the instructions 24A cause measurements on the quantum circuit 12 using the modulators 34 and demodulators 36. A measurement of one or more physical qubits 14 is the result of sending a signal via the modulator 34 and receiving a signal back via the demodulator 36. The received signal, also referred to as the measurements, has the quantum information about the logical qubit that is formed of two or more physical qubits 14. Based on a signal sent and the received signal from the quantum circuit 12, a logical qubit is formed of two or more physical qubits 14 as understood by one of ordinary skill in the art. The various signals sent and corresponding signals received back can be performed using the scheme or code that follows/adheres to plaquettes, as understood by one of ordinary skill in the art.

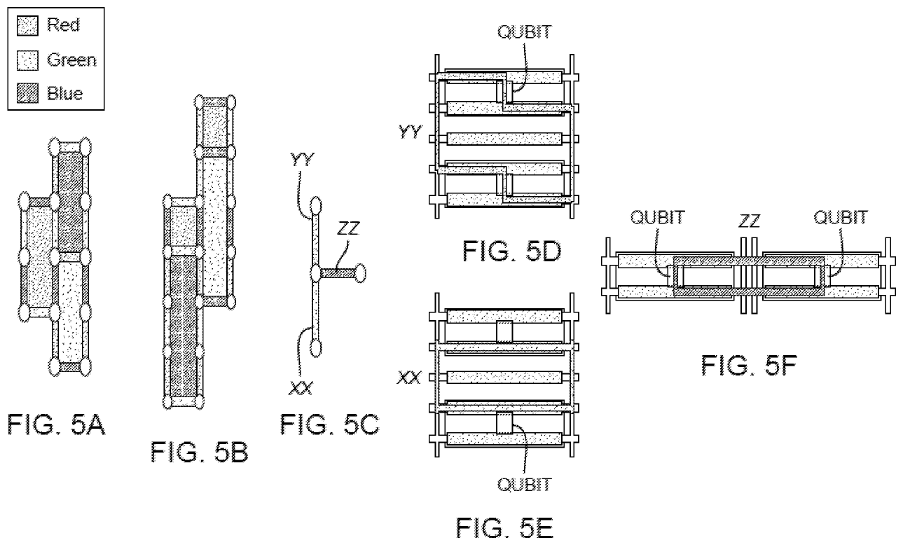

Some examples of measurements are illustrated in FIGS. 5A, 5B, 5C, 5E, and 5F. FIG. 5A illustrates a vertical brick wall unit of a honeycomb lattice. FIG. 5B illustrates a vertical brick wall unit of the 4.8.8 lattice. FIG. 5C illustrates the directions for XX, YY, and ZZ measurements. FIG. 5D illustrates example bulk YY measurements. FIG. 5E illustrates example bulk XX measurements. FIG. 5F illustrates example bulk ZZ measurements. Colors are represented in FIGS. 5A, 5B, 5C, 5D, 5E, and 5F. The colors refer to the measurement time steps, rather than the Pauli operators. It is noted that the different colors describe the 3-coloring of the plaquettes and corresponding checks. The honeycomb and 4.8.8 lattices map to the tetron array of tetrons 410 of the quantum circuit 12 in FIG. 4 using vertical bricks such that each 2n-gon corresponds to a rectangle of height n. With this mapping, the honeycomb and 4.8.8 Floquet codes in the bulk use a subset of the highest fidelity two-qubit measurements: XX and YY measurements between vertically adjacent qubit islands in FIGS. 5E and 5D respectively, and ZZ between horizontally adjacent qubit islands in FIG. 5F. To implement measurements on neighboring pairs of vertically adjacent qubits without their corresponding loops intersecting, the two columns of semiconductor segments 420 separating each column of qubit islands 404, which are the qubits 14, can be utilized.

A previous paper of a layout of the 4.8.8 code using Majorana based architectures has been presented in by Adam Paetznick, Christina Knapp, Nicolas Delfosse, Bela Bauer, Jeongwan Haah, Matthew B. Hastings, and Marcus P. da Silva, in Performance of planar floquet codes with majorana-based qubits, PRX Quantum, 4:010310, Jan. 25, 2023, which is herein incorporated by reference.

The Hastings-Haah code is implemented in the instructions 24A in the quantum computer 10. In one or more embodiments, the Hastings-Haah code can be implemented as computer-executable instructions in the classical computer 100 and sent to the quantum computer 10 for execution. The 4.8.8 Hastings-Haah code uses “4.8.8” to refer to a lattice. As understood by one of ordinary skill in the art, “Hastings-Haah code” denotes a technique of operating the 2D array of qubits 14 in the quantum circuit 12. Moreover, the Hastings-Haah code is a sequence of two qubit measurements on the quantum circuit 12 of the quantum computer 10, and the classical computer 100 eventually stores those measurement outcomes. That sequence of two qubit measurements is programmed into the classical computer 100, which then sends signals to the quantum computer 10, indicating which operations to perform on the quantum circuit 12.

The disclosure provides a discussion techniques that are utilized in the Clifford synthesis algorithm 130 executed on, for example, the classical computer 100 in operative communication with the quantum computer 10 in order to control one or more operations on the quantum computer 10. Headings are utilized for ease of understanding and to assist the reader. The headings are not meant to be limiting.

### 1. Pauli Unitaries

One can recall that one-qubit Pauli matrices are

$$I = ( \begin{matrix}1 & 0 \\ 0 & 1\end{matrix} ) , X = ( \begin{matrix}0 & 1 \\ 1 & 0\end{matrix} ) , Y = ( \begin{matrix}0 & - i \\ i & 0\end{matrix} ) , Z = ( \begin{matrix}1 & 0 \\ 0 & - 1\end{matrix} ) ,$$

and the n-qubit Pauli matrices are {I, X, Y, Z}^{⊗n}, which are the n-fold tensor products of one qubit Pauli matrices. Pauli observables are n-qubit Hermitian matrices ±{I, X, Y, Z}^{⊗n}. For one-qubit Pauli observables P, the disclosure defines x bits x(P) as: x(±I)=0, x(±X)=1, x(±Y)=1, x(±Z)=0, and z bits z(P) as: z(±I)=0, z(±X)=0, z(±Y)=1, z(±Z)=1.

For n-qubit Pauli observable P=±P₁⊗ . . . ⊗Pₙ, the disclosure defines x and z bits as: x(P)=(x(P₁), . . . , x(Pₙ)), z(P)=(z(P₁), . . . , z(Pₙ)).

It is known that the group commutator of two Pauli observables P, Q can be written as [symbol] P, Q [symbol] =PQP^{†}Q^{†}= [symbol] (I⊗ . . . ⊗I), where [symbol] x(P), z(Q) [symbol] is the inner product of vectors x(P), z(Q) with addition and multiplication modulo 2, that is 1+1=0.

It is known to use Xⱼ, Zⱼ for n-qubit Pauli observable acting as X, Z on qubit j and as I on the rest of the qubits.

Finally, it should be recalled that the group commutator of two Pauli observables is related to a symplectic inner product. One can rewrite sum [symbol] x(P), z(Q) [symbol] + [symbol] z(P), x(Q) [symbol] as an inner product of vectors z(P)⊕x(P) and z(Q)⊕x(Q), where ⊕ denotes the direct sum of two vectors. Define 2n×2n matrix Ω as

$$Ω = ( \begin{matrix}0 & {I}_{n} \\ {I}_{n} & 0\end{matrix} ) , \qquad Eq . ( 1 )$$

where Iₙ is n×n identity matrix. Using matrix Ω one has: [symbol] x(P), z(Q) [symbol] + [symbol] z(P), x(Q) [symbol] = [symbol] Ω(z(P)⊕x(P)), z(Q)⊕x(Q) [symbol] .

Again, all the addition and multiplication operations are modulo two. Map x, y [symbol] [symbol] Ωx, y [symbol] is an example of a symplectic inner product.

### 2. Clifford Unitaries

Clifford unitaries can also be referred to as Clifford gates. It should be recalled that unitary C is a Clifford unitary if it maps Pauli observables to Pauli observables by conjugation; that is, for any Pauli observable P, one has CPC^{†} also as a Pauli observable. It is common to associate with a Clifford unitary C a 2n×2n matrix with {0,1}-entries:

$${M}_{C} = ( \begin{matrix}{A}_{x , x} & {A}_{x , z} \\ {A}_{z , x} & {A}_{z , z}\end{matrix} ) , \qquad ( Eq . ( 2 ) )$$

where rows of matrices A_{z,z}, A_{z,x}, A_{x,z}, A_{x,x} are defined by the following equations:

(A_{z,z})ⱼ=z(CZⱼC^{†}),(A_{z,x})ⱼ=x(CZⱼC^{†}),j∈{1, . . . ,n}

(A_{x,z})ⱼ=z(CXⱼC^{†}),(A_{x,x})ⱼ=x(XZⱼC^{†}),j∈{1, . . . ,n}.

It should be recalled that conjugation by a Clifford unitary preserves group commutator, therefore:

[symbol]

CC^{†},CXⱼC^{†} [symbol] = [symbol] Zⱼ,Xₖ

[symbol]

[symbol]

CZⱼC^{†},CZⱼC^{†} [symbol] = [symbol] Zⱼ,Zₖ

[symbol]

[symbol]

CXⱼC^{†},CXⱼC^{†} [symbol] = [symbol] Xⱼ,Xₖ [symbol] .

The relation between Pauli observables group commutator and a symplectic inner product implies that M_{C} is a symplectic matrix; that is M_{C}^{T}Ω_{MC}=Ω, where Ω is defined in Eq. (1). Note that matrix M_{C} defines Clifford unitary C up to multiplication by a Pauli matrix P and global phase e^{iϕ}; that is for unitaries C and D, equality M_{C}=M_{D} implies that there exist Pauli matrix P and real number ϕ such that C=e^{iϕ}DP. Additionally, M_{CD}=M_{C}M_{D} and any symplectic matrix corresponds to Clifford unitary. For these reasons, questions about synthesis of Clifford unitaries are closely related to the results on symplectic matrices with entries in the field [symbol] , that is a field with elements {0,1} and addition, multiplication modulo two.

Some common examples of Clifford unitaries are noted. The S unitary is a one-qubit matrix

$${{e}^{-}}^{\frac{i πZ}{4}} ,$$

and the CZ unitary is a two-qubit matrix

$${e}^{i π ( I - Z ) ⊗ \frac{I - Z}{4}} .$$

Their corresponding symplectic matrices M_{S} and M_{CZ} respectively are

$${M}_{S} = ( \begin{matrix}1 & 1 \\ & 1\end{matrix} ) , {M}_{CZ} = ( \begin{matrix}1 & & 0 & 1 \\ & 1 & 1 & 0 \\ & & 1 & \\ & & & 1\end{matrix} ) . \qquad ( Eq . ( 3 ) )$$

The generalized S gate is defined for a Pauli observable P as

$${e}^{\frac{i π P}{4}} .$$

The generalized CZ gate is defined for two commuting independent Pauli observables P, Q as

$$Λ ( P , Q ) = {e}^{\frac{i π ( I - P ) ( I - Q )}{4}} .$$

Conjugating S acting on the first qubit and CZ acting on the first two qubits by a Clifford unitary C maps them to generalized S and CZ gates with P=CZ₁C^{†}, Q=CZ₂C^{†}.

Pauli unitary on n-qubits is represented as a sequence of n letters I, X Y, Z corresponding to the four one qubit Pauli matrices, so that P=P₁⊗ . . . ⊗Pₙ, Pₖ∈{I, X Y, Z}, and this corresponds to finding a Pauli unitary P.

Any n-qubit Clifford unitary C can be fully described by a (2n+1)×(2n+1) binary matrix, thereby disclosing how to input n-qubit Clifford unitary C. The binary symplectic matrix M_{C} in Eq. (7) (discussed below) corresponds to the top-left 2n×2n sub-matrix of the (2n+1)×(2n+1) describing Clifford unitary C completely. When Clifford unitaries are represented by (2n+1)×(2n+1) matrices, their product and inverse (denoted by †) can be computed efficiently. A Clifford unitary C, for which the binary symplectic matrix M_{C} is identity, is a Pauli unitary. When one is given a Clifford unitary C (as (2n+1)×(2n+1) matrix) such that, M_{C} is identity, it is well known how to find a Pauli unitary P (given as a list of letters I, X, Y, Z) that is equal to C up to a global phase.

It can be said that Clifford unitary B₁ is such that M_{B1}=F₁ for some binary-symplectic matrix F₁, and this means that B₁ is represented by (2n+1)×(2n+1) binary matrix with top-left 2n×2n part equal to F₁ and the rest of the entries chosen to be consistent with the requirements of storing a Clifford unitary as (2n+1)×(2n+1) matrix.

### 3. Symplectic Matrices

It should be recalled that a symplectic matrix over [symbol] is a 2n×2n matrix M such that M^{T}ΩM=Ω where Ω is defined in Eq. (1). A symplectic matrix M is a symplectic involution if M²=I₂ₙ, such that a square of M is a 2n×2n identity matrix.

There are two notable results on involutions of symplectic matrices over [symbol] . The first one is:

Theorem 1. Each symplectic matrix is a product of two symplectic involutions.

This result implies that any question about finding a circuit for a Clifford unitary C can be reduced to a question about finding circuits for Clifford unitaries B, D such that M_{C}=M_{B}M_{D} and M_{B}²=I, M_{D}²=I. The next notable result is the result on the structure of symplectic involutions.

Theorem 2. Let R be a 2n×2n symplectic involution, then there exists a symplectic matrix M, such that

$${M}^{- 1} RM = ( \begin{matrix}I & A \\ & I\end{matrix} ) , A = ( \begin{matrix}{A}^{′} & \\ & 0\end{matrix} ) \qquad ( Eq . ( 4 ) )$$

where A′ is an identity matrix, or A′ is a block-diagonal matrix:

$${A}^{′} = ( \begin{matrix}0 & 1 & & & \\ 1 & 0 & & & \\ & & ⋱ & & \\ & & & 0 & 1 \\ & & & 1 & 0\end{matrix} ) . \qquad ( Eq . ( 5 ) )$$

Matrices M_{S}, M_{CZ} from Eq. (3) are involutions and in form given by Eqs. (4) and (5) with M=I. An immediate corollary of the Theorem 2 is that, for any n-qubit Clifford unitary B such that M_{B} is an involution, there exist a Clifford unitary C such that one of the following holds:
(A) there exist k≤n, Pauli P, real number

$$ϕ : B = {e}^{i ϕ} C ( {S}^{{}^{⊗} k} ⊗ {I}^{⊗ n - k} ) {C}^{†} P , or \qquad ( Eq . ( 6 ) )$$

(B) there exist

$$k \leq \frac{n}{2} ,$$

Pauli P, real number

$$ϕ : B = {e}^{i ϕ} C ( {CZ}^{{}^{⊗} k} ⊗ {I}^{⊗ n - 2 k} ) {C}^{†} P . \qquad ( Eq . ( 7 ) )$$

The alternative (A) corresponds to the case where A′ is a k×k identity matrix and the alternative (B) corresponds to the case when A′ is a 2k×2k block-diagonal matrix, which expresses how to define k. In other words, any Clifford unitary B with M_{B} being a symplectic involution is a product of either generalized S or generalized CZ gates.

### 4. Remote Execution of Diagonal Gates and Circuits for Generalized S and CZ Gates.

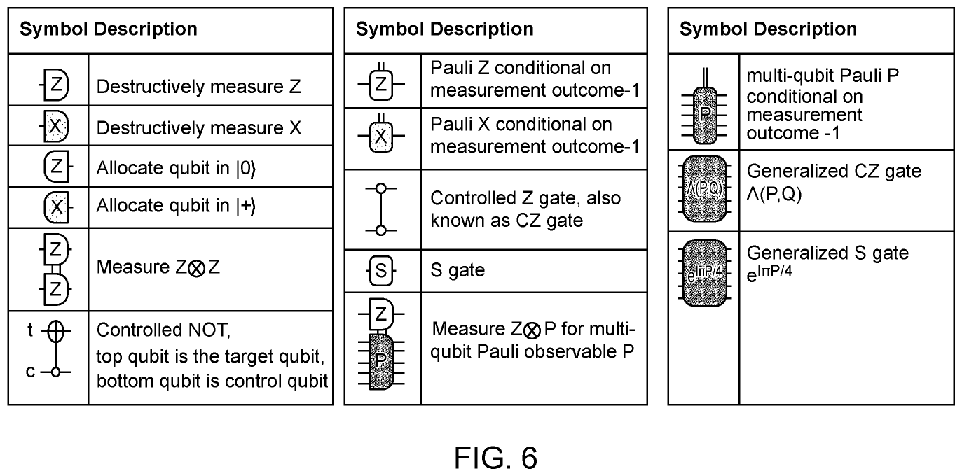

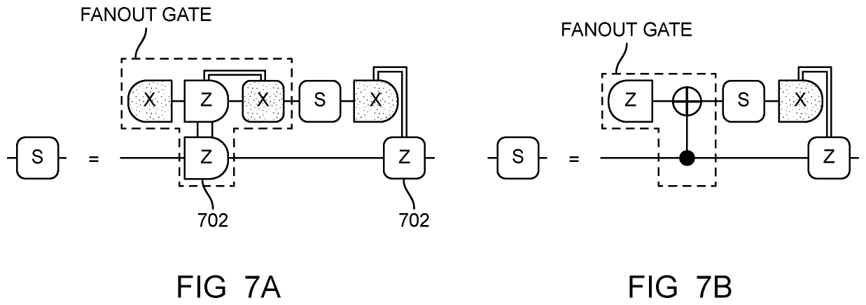

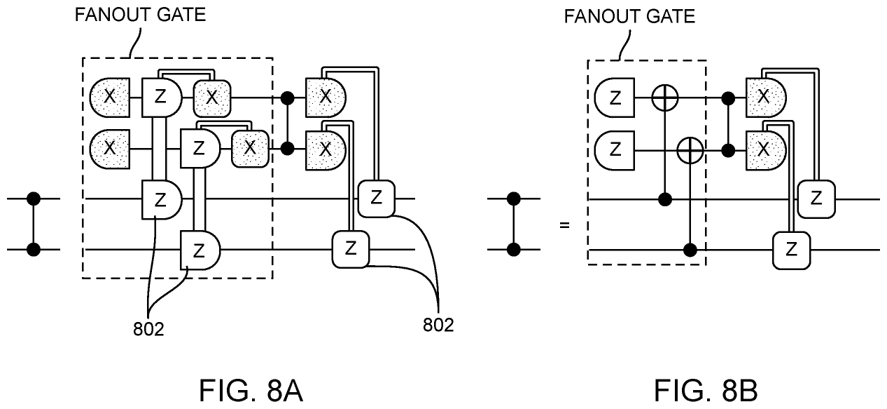

FIG. 6 illustrates examples of quantum circuit notation for computations using logical qubits that are formed by one or more physical qubits 14. The disclosure can use quantum circuit diagram notation in FIG. 6. It is noted that circuits in FIGS. 7A and 7B and FIGS. 8A and 8B for remote execution of diagonal gates lead to circuits for execution of generalized S gates and generalized CZ gates, respectively, during Parallel Synthesis Sequential Pauli Computation.

FIGS. 7A and 7B illustrate remote execution of an S gate. The circuit in FIG. 7B is previously described by Michael Beverland, Vadym Kliuchnikov, and Eddie Schoute, Surface code compilation via edge-disjoint paths. PRX Quantum, 3:020342, May 2022. arXiv:2110.11493, doi:10.1103/PRXQuantum.3.020342. The circuit in FIG. 7A is obtained from the circuit in FIG. 7B in which FIG. 7A replaces the CNOT-based fanout gate with a measurement-based fanout gate.

FIGS. 8A and 8B illustrate remote execution of a CZ gate. The circuit in FIG. 8B is further described in Surface code compilation via edge-disjoint paths above. The circuit in FIG. 8A is obtained from the circuit FIG. 8B by replacing the CNOT-based fanout gate with a measurement-based fanout gate.

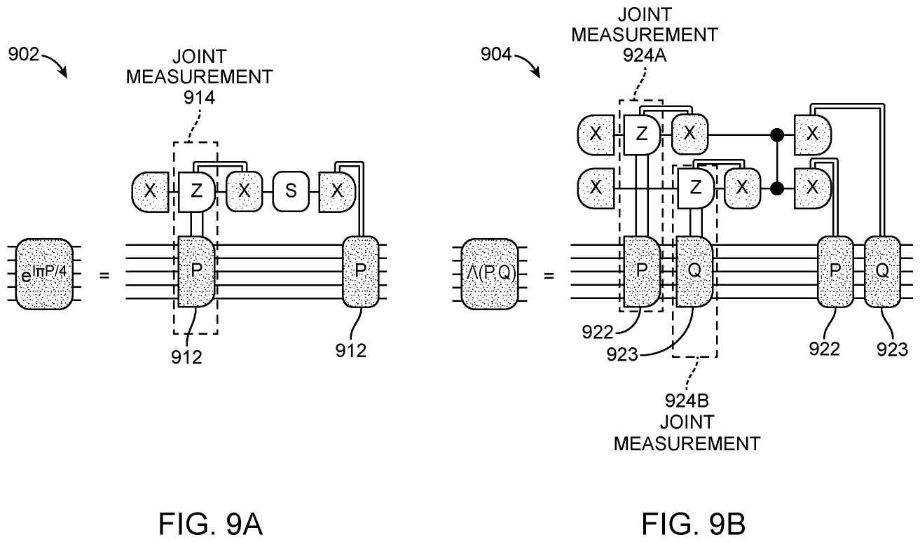

FIGS. 9A and 9B illustrate circuits for executing generalized Clifford S and CZ gates, respectively, in accordance with one or more embodiments. FIG. 9A illustrates a circuit for executing a Clifford S gate using one Pauli measurement 914. FIG. 9B illustrates a circuit for executing a Clifford CZ gate using two multi-qubit Pauli measurements 924A and 924B.

It is recalled that for any commuting independent Pauli observables P, Q, there exists a Clifford unitary C such that CZ₁C^{†}=P and CZ₂C^{†}=Q. Conjugating the bottom qubit 702 in the circuit in FIG. 7A by such Clifford unitary C leads to the circuit 902 for the generalized S gate in FIG. 9A. Conjugating the bottom two qubits 802 in the circuit in FIG. 8A by such Clifford unitary C leads to the circuit 904 for the generalized CZ gate in FIG. 9B. If one is interested in using generalized CZ gates Λ(X₁, P), Λ(X₂, Q), instead of multi-qubit joint measurement Z₁P, Z₂Q in FIGS. 9A and 9B, it is sufficient to conjugate the bottom half of the qubits in the circuits in FIGS. 7B and 8B.

### 3. Clifford Synthesis Algorithm

The Clifford synthesis algorithm 130 is executed on the classical computer 100 causing the quantum computer 10 to execute instructions 24A on controller 18A for measurements on the physical qubits 14A-14N in accordance with the Clifford synthesis algorithm 130. For explanation purposes and not limitation, the following example of the Clifford synthesis algorithm 130 is provided below. The Clifford synthesis algorithm 130 in configured to perform Clifford synthesis via involutions. The input to the Clifford synthesis algorithm 130 is the following: an n-qubit Clifford unitary C that can be expressed as a matrix M_{C} after mapping Pauli observables to Pauli observables by conjugation as discussed in Section 2. The output of the Clifford synthesis algorithm 130 is discussed below. The Clifford synthesis algorithm 130 includes the following:

1: Decompose M_{C} into a product of two involutions M₁M₂ using

Theorem 2.1.

2: Find symplectic matrices F₁, F₂ that bring M₁, M₂ into a special

form with matrices A₁′, A′₂ using Theorem 2.2.

| 3: Let B₁, B₂ be Clifford unitaries such that M_{B}_{₁} = F₁, M_{B}_{₂} = F₂. | |
|---|---|
| 4: if A₁′ is a diagonal matrix then | |
| 5: | Set k to size of A₁′ |
| 6: | Set s₂ to sequence e^{iπB}^{₁}^{Z}^{₁}^{B}^{₁}^{^{†}}, ... , e^{iπB}^{₁}^{Z}^{ₖ}^{B}^{₁}^{^{†}} |
| 7: else | > A₁′ is a block-diagonal matrix |
| 8: | Set k to half of the size of A₁′ |
| 9: | Set s₂ to sequence |

Λ(B₁Z₁B₁^{†}, B₁Z₂B₁^{†}), ... , Λ(B₁Z₂ₖ₋₁B₁^{†}, B₁Z₂ₖB₁^{†})

| | 10: if A₂′ is a diagonal matrix then | |
|---|---|---|
| | 11: | Set k to size of A₂′ |
| | 12: | Set s₁ to sequence e^{iπB}^{₂}^{Z}^{₂}^{B}^{₁}^{^{†}}, ... , e^{iπB}^{₂}^{Z}^{ₖ}^{B}^{₂}^{^{†}} |
| 13: else | | >A₂′ is a block-diagonal matrix |
| | 14: | Set k to half of the size of A₂′ |
| | 15: | Set s₁ to sequence |

Λ(B₂Z₁B₂^{†}, B₂Z₂B₂^{†}), ... , Λ(B₂Z₂ₖ₋₁B₂^{†}, B₂Z₂ₖB₂^{†})

16: Set P ← (Π_{g∈s}_{₂} g)(Π_{g∈s}_{₁} g)C^{†}
17: return s₁, s₂, P.

Technical solutions and benefits provide techniques to execute the Clifford unitary C on the quantum computer 10 using the circuits in FIGS. 9A and 9B by executing the Clifford synthesis algorithm 130 on the classical computer 100. As discussed herein, the Clifford unitary C is given as the input and specifies what is to be performed on the quantum computer 10 by executing the Clifford synthesis algorithm 130 on the classical computer 100, such that the output of the Clifford synthesis algorithm 130 is a sequence of operations s₁ and s₂ and a Pauli unitary P operation, which are executed on the quantum computer 10.

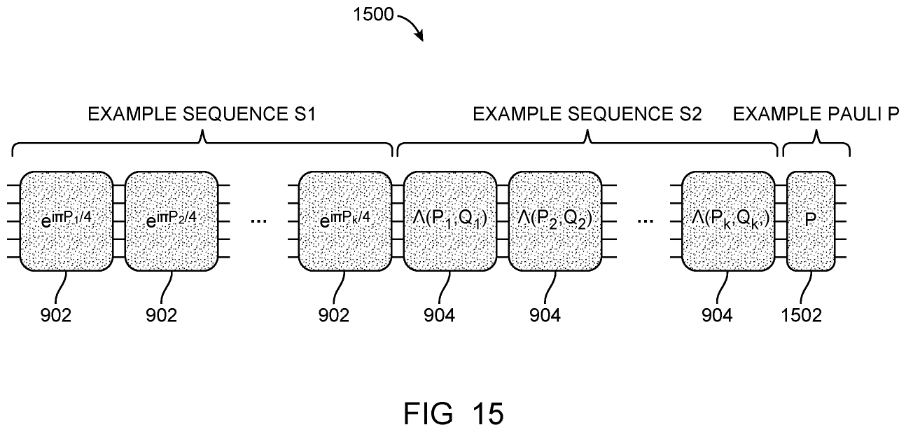

The output of Clifford synthesis algorithm 130 is sequences s₁, s₂ of generalized S and CZ gates, and Pauli unitary P, such that: gates from sequences s₁ and s₂ are followed by Pauli P implement Clifford unitary C as depicted in FIGS. 9A and 9B and an example in FIG. 15. Generalized S and CZ gates from s₁ are implemented using mutually-commuting measurements as depicted FIGS. 9A and 9B, while generalized S and CZ gates from s₂ are implemented using mutually-commuting measurements as depicted in FIGS. 9A and 9B. The sequences s₁, s₂ both require at most n measurements when using circuits in FIGS. 9A and 9B. As noted herein, n refers to the number of logical qubits to which one applies the Clifford unitary C, and the n number of logical qubits utilized to store algorithm data to solve the problem using physical qubits 14 on the quantum computer 10. It is understood that there can be other logical qubits that assist with measurements, etc., which are not the n number of logical qubits utilized to store algorithm data.

Now, turning to further details for the sequence s₂ in the output in line 17, the sequence s₂ is obtained by meeting the condition to execute line 6 (e.g., the circuit 902 in FIG. 9A) or meeting the condition to execute line 9 (e.g., the circuit 904 in FIG. 9B) of the Clifford synthesis algorithm 130. When executing line 6 for setting s₂ to sequence e^{iπB}^{₁}^{Z}^{₁}^{B}^{₁}^{^{†}}, . . . , e^{iπB}^{₁}^{Z}^{ₖ}^{B}^{₁}^{^{†}}, the output for sequence s₂ is a series of k number of circuits 902 for

$${e}^{\frac{i π P}{4}}$$

such as, for example, a first circuit

$${e}^{\frac{i π P}{4}} ,$$

a second circuit

$${e}^{\frac{i π P}{4}} ,$$

through the kth circuit

$${e}^{\frac{i π P}{4}} ,$$

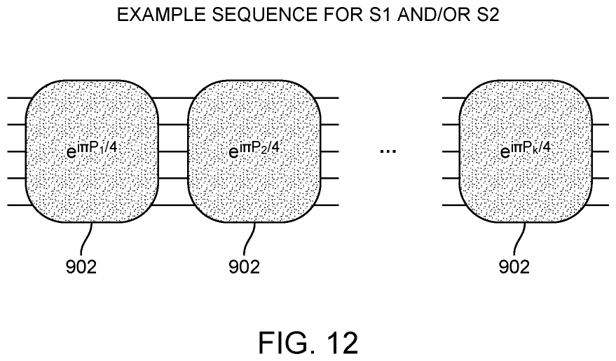

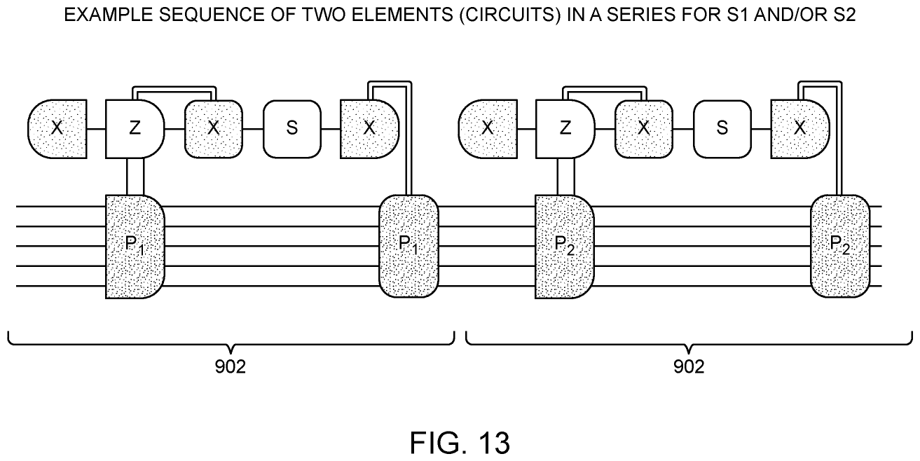

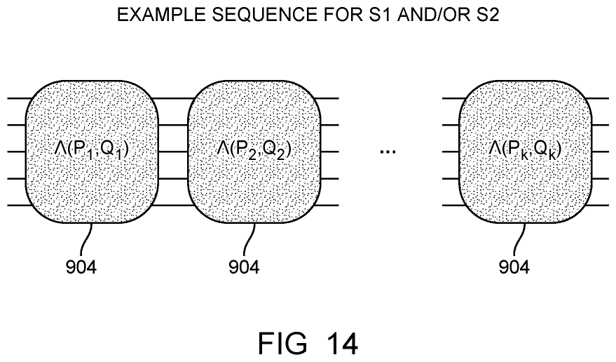

as illustrated by the example sequence s₂ (and/or sequence s₁) depicted in FIG. 12. FIG. 13 depicts sequence s₂ (and/or sequence s₁) where there are two elements (e.g., two circuits 902) in the series, where P is BⱼZⱼBⱼ^{†} for j between 1 and k. As can be seen in the circuit 902 in FIG. 9A, the Pauli P circuit operators 912 replace the qubits 702 in FIG. 7A, where there is one joint qubit measurement 914 for one Pauli circuit operator 912. Analogously, when executing line 9 for setting s₂ to sequence Λ(B₁Z₁B₁^{†}, B₁Z₂B₁^{†}), . . . , Λ(B₁Z₂ₖ₋₁B₁^{†}, B₁Z₂ₖB₁^{†}), the output for sequence s₂ is a series of k number of circuits 904 for Λ(P, Q) such as, for example, a first circuit Λ(P, Q), a second circuit Λ(P, Q), through the kth circuit Λ(P, Q), as illustrated by the example sequence s₂ (and/or sequence s₁) depicted in FIG. 14. Operator P is B₂ⱼ₋₁Z₂ⱼ₋₁B₂ⱼ₋₁^{†} and operator Q is B₂ⱼZ₂ⱼB₂ⱼ^{†} for j between l and k. As can be seen in the circuit 904 in FIG. 9B, the Pauli P circuit operators 922 and Q circuit operators 923 replace the qubits 802 in FIG. 8A. In circuit 904, there are two joint qubit measurements which are joint qubit measurement 924A for a Pauli circuit operator 922 and another joint qubit measurement 924B for Q circuit operator 923.

Now, turning to further details for sequence s₁, the output for sequence s₁ is analogous to the output for sequence s₂. For the sequence s₁ in the output in line 17, the sequence s₁ is obtained by meeting the condition to execute line 12 (e.g., the circuit 902 in FIG. 9A) or meeting the condition to execute line 15 (e.g., the circuit 904 in FIG. 9B) of the Clifford synthesis algorithm 130. When executing line 12 for setting s₁ to sequence e^{iπB}^{₂}^{Z}^{₂}^{B}^{₁}^{^{†}}, . . . , e^{iπB}^{₂}^{Z}^{ₖ}^{B}^{₂}^{^{†}}, the output for sequence s₁ is a series of n number of circuits 902 for

$${e}^{\frac{i π P}{4}}$$

such as, for example, a first circuit

$${e}^{\frac{i π P}{4}} ,$$

a second circuit

$${e}^{\frac{i π P}{4}} ,$$

through the kth circuit

$${e}^{\frac{i π P}{4}} ,$$

illustrated by the example sequence s₁ (and/or sequence s₂) depicted in FIG. 12. FIG. 13 depicts sequence s₁ (and/or sequence s₂) where there are two elements (circuits 902) in the series. As can be seen in the circuit 902 in FIG. 9A, the Pauli P circuit operators 912 replaces qubits 702 in FIG. 7A, where there is one joint qubit measurement 914 that includes the circuit operator 912. Analogously, when executing line 15 for setting s₁ to sequence Λ(B₂Z₁B₂^{†}, B₂Z₂B₂^{†}), . . . , Λ(B₂Z₂ₖ₋₁B₂^{†}, B₂Z₂ₖB₂^{†}), the output for sequence s₁ is a series of n number of circuits 904 for Λ(P, Q) such as, for example, a first circuit Λ(P, Q), a second circuit Λ(P, Q), through the kth circuit Λ(P, Q), as illustrated by the example sequence s₁ (and/or sequence s₂) depicted in FIG. 14. As can be seen in the circuit 904 in FIG. 9B, the Pauli P circuit operators 922 replace the qubits 802 in FIG. 8A. In circuit 904, there are two joint qubit measurements which are joint qubit measurement 924A that include the Pauli circuit operator 922 and another joint qubit measurement 924B for Q circuit operator 923.

As can be seen from the Clifford synthesis algorithm 130, there are different combinations for the sequences s₁, s₂ in accordance with the execution of line 6 or 9 for the sequence s₂ and execution of line 12 or 15 for the sequence s₁. Further discussion of conditions for the different combinations is provided below.

In lines 4-9, there are two cases for determining the sequence s₂. For the first case, in line 5 of the Clifford synthesis algorithm 130 in which k is set to the size of A₁′, k is less than or equal to n as expressed in the condition for Eq. (6) in Section 3, which leads to using the circuit 902 in FIG. 9A. In Section 3, k is the size of either the row or column in A′, where the identity matrix A′ is k×k. For the second case, in line 8 of the Clifford synthesis algorithm 130 in which k is set to half the size of A₁′, k is less than or equal to as expressed in the condition for Eq. (7) in Section 3. Again, k is the size of either the row or column in A′, where the identity matrix A′ is k×k.

In lines 10-15, there are two cases for determining the sequence s₁. For the first case, in line 10 of the Clifford synthesis algorithm 130 in which k is set to the size of A₂′, k is less than or equal to n as expressed in the condition for Eq. (6) in Section 3, which leads to using the circuit 902 in FIG. 9A. In Section 3, k is the size of either the row or column in A′, where the identity matrix A′ is k×k. For the second case, in line 14 of the Clifford synthesis algorithm 130 in which k is set to half the size of A₂′, k is less than or equal to n/2 as expressed in the condition for Eq. (7) in Section 3. Again, k is the size of either the row or column in A′, where the identity matrix A′ is k×k.

Although there are other combinations for the results in line 17, FIG. 15 depicts an example of sequence s₁ implemented with a series of circuits 902, followed by a sequence s₂ implemented with a series of circuits 904, which is followed by the added unconditional Pauli unitary P circuit 1502, all of which is an example of an output 1500 of line 17 generated by the Clifford synthesis algorithm 130. In the example of FIG. 15, sequence s₁ is a series of Pauli exponents, that is generalized S gates,

$$( {e}^{\frac{i π P}{4}} )$$

represented by circuits 902, and the sequence s₂ is a series of generalized CZ gates (Λ(P, Q)) represented by circuits 904. The classical computer 100 causes the quantum computer 10 to execute the output 1500. The output 1500 is equivalent to a logical circuit that is input to and executed by the quantum computer 10. The unconditional Pauli unitary P circuit 1502 is unconditional because it is always executed. In contrast, the Pauli P circuit operators 912 and 922 are executed conditioned on the measurement outcome being −1.

Although not shown in FIG. 15, the sequence s₁ could be a series of generalized CZ gates, the sequence s₂ could be a series of Pauli exponents, and the Pauli P circuit 1502 is added, according to one or more embodiments. Although not shown in FIG. 15, the sequence s₁ could be a series of Pauli exponents, the sequence s₂ could be a series of Pauli exponents, that is generalized S gates, and the Pauli P circuit 1502 is added, according to one or more embodiments. Although not shown in FIG. 15, the sequence s₁ could be a series of generalized CZ gates, the sequence s₂ could be a series of generalized CZ gates, and the Pauli P circuit 1502 is added, according to one or more embodiments.

As noted herein, any n-qubit Clifford unitary can be implemented using at most 2n multi-qubit joint measurements. When the Clifford synthesis algorithm 130 outputs a sequence that uses the circuit 902 in FIG. 9A, (only) one joint qubit measurement 914 is utilized in each element in the sequence, according to one or more embodiments. When the Clifford synthesis algorithm 130 outputs a sequence that uses the circuit 904 in FIG. 9B, (only) two joint qubit measurements 924A and 924B are utilized in each element in the sequence, according to one or more embodiments.

The following provides an example as a brief discussion of the algorithm correctness. Let C₁=(Π_{g∈S}_{₁} g), C₂=(Π_{g∈S}_{₂} g) be the Clifford unitaries implemented by sequences of gates s₁, s₂. It follows that M_{C}_{₁}=M₁, and M_{C}_{₂}=M₂, and consequently M_{C}=M_{C}_{₁}M_{C}_{₂}. Indeed, symplectic matrices of products e^{iπZ}^{₁}, . . . , e^{iπZ}^{ₖ} or Λ(Z₁, Z₂), . . . , Λ(Z₂ₖ₋₁, Z₂ₖ), correspond to F₁⁻¹M₁F₁. Conjugating products e^{iπZ}^{₁}, . . . , e^{iπZ}^{ₖ} or Λ(Z₁, Z₂), . . . , Λ(Z₂ₖ₋₁, Z₂ₖ) by B₁ gives C₁ and s₁ and transforms F₁⁻¹M₁F₁ into M₁. Similarly, it can be seen that M_{C}_{₂}=M₂. Each of the sequences s₁, s₂ is implemented using joint measurements Z⊗B₁ZⱼB₁^{†}, Z⊗B₂ZⱼB₂^{†}, which forms two sets of mutually-commuting measurements, as required. Finally, the number of measurements in each group is equal to the size of A₁′, A′₂ and are less than n.

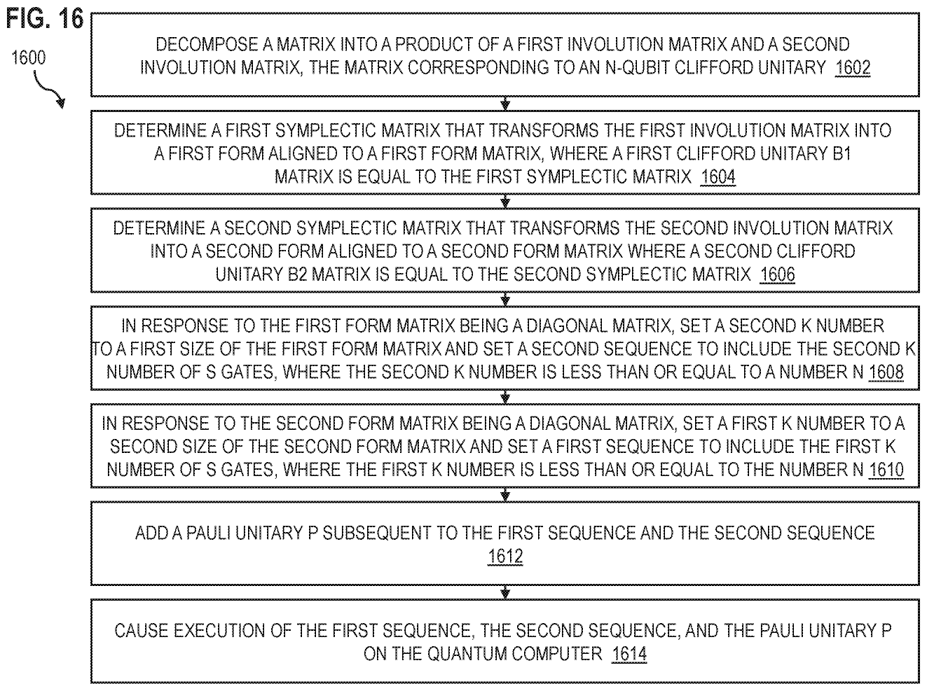

FIG. 16 is a flowchart of a computer-implemented method 1600 for operating a quantum computer, by performing Clifford unitary synthesis via generalized phase gate (S) and controlled-Z (CZ) gates to execute a Clifford unitary on the quantum computer. Reference can be made to any of the figures discussed herein.

At block 1602, the Clifford synthesis algorithm 130 of the classical computer 100 is configured to decompose a matrix (e.g., matrix M_{C}) into a product of a first involution matrix (e.g., involution M₁) and a second involution matrix (e.g., involution M₂), the matrix (e.g., matrix M_{C}) corresponding to an n-qubit Clifford unitary.

At block 1604, the Clifford synthesis algorithm 130 is configured to determine a first symplectic matrix (e.g., symplectic matrix F₁) that transforms the first involution matrix (e.g., involution M₁) into a first form aligned to a first form matrix (e.g., matrix A₁′), wherein a first Clifford unitary B1 matrix is equal to the first symplectic matrix (e.g., symplectic matrix F₁).

At block 1606, the Clifford synthesis algorithm 130 is configured to determine a second symplectic matrix (e.g., symplectic matrix F₂) that transforms the second involution matrix (e.g., involution M₂) into a second form aligned to a second form matrix (e.g., matrix A₂′) wherein a second Clifford unitary B2 matrix is equal to the second symplectic matrix (e.g., symplectic matrix F₂).

At block 1608, the Clifford synthesis algorithm 130 is configured to, in response to the first form matrix (e.g., matrix A₁′) being a diagonal matrix, set a second k number to a first size of the first form matrix (e.g., matrix A₁′) and set a second sequence (e.g., sequence s₂) to include the second k number of S gates (e.g., S gate circuit 902), where the second k number is less than or equal to a number n.

At block 1610, the Clifford synthesis algorithm 130 is configured to, in response to the second form matrix (e.g., matrix A₂′) being a diagonal matrix, set a first k number to a second size of the second form matrix (e.g., matrix A₂′) and set a first sequence (e.g., sequence s₁) to include the first k number of S gates (e.g., S gate circuit 902), where the first k number is less than or equal to the number n.

At block 1612, the Clifford synthesis algorithm 130 is configured to add a Pauli unitary P (e.g., Pauli unitary P 1502) subsequent to the first sequence and the second sequence.

At block 1614, the Clifford synthesis algorithm 130 is configured to cause execution of the first sequence (e.g., sequence s₁), the second sequence (e.g., sequence s₂), and the Pauli unitary P (e.g., Pauli unitary P 1502) on the quantum computer 10.

In one or more embodiments, the execution of the first sequence, the second sequence, and the Pauli unitary P on the quantum computer 10 has the same effect as executing the n-qubit Clifford unitary and changes states of the qubits in the same way as the n-qubit Clifford unitary. The execution of the first sequence is implemented using (or by causing) mutually-commuting measurements of the quantum computer 10. The execution of the second sequence is implemented using (or by causing) mutually-commuting measurements of the quantum computer 10. The number n is a number of logical qubits (e.g., formed of one or more physical qubits 14) utilized to store data to execute the n-qubit Clifford unitary. The first sequence and the second sequence each require at most the n number of measurements, for example, for each element in the series.

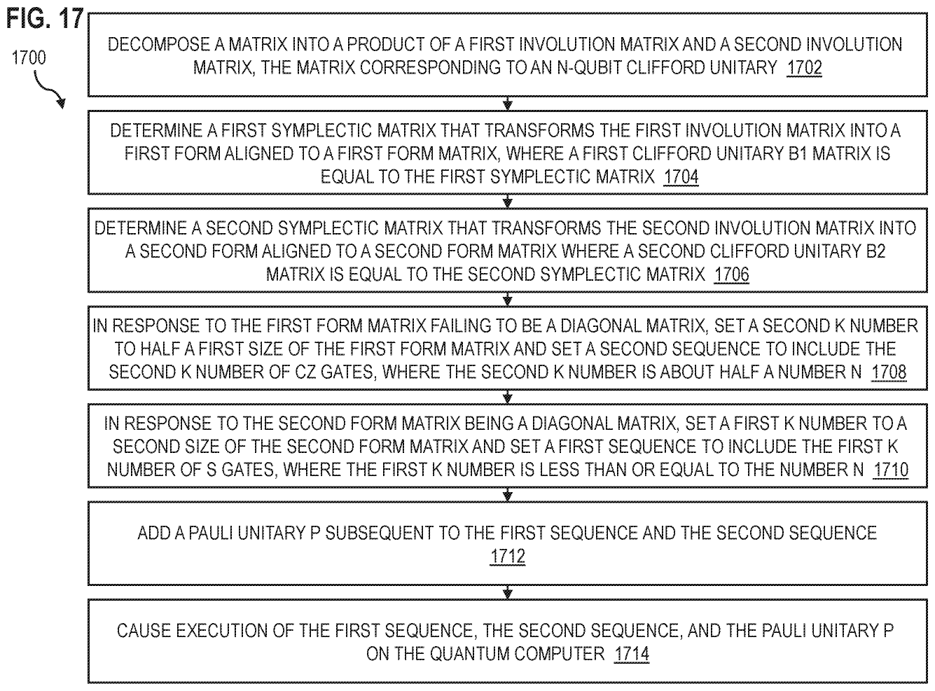

FIG. 17 is a flowchart of a computer-implemented method 1700 for operating a quantum computer, by performing Clifford unitary synthesis via generalized phase gate (S) and controlled-Z (CZ) gates to execute a Clifford unitary on the quantum computer. Reference can be made to any of the figures discussed herein.

At block 1702, the Clifford synthesis algorithm 130 of the classical computer 100 is configured to decompose a matrix (e.g., matrix M_{C}) into a product of a first involution matrix (e.g., involution M₁) and a second involution matrix (e.g., involution M₂), the matrix (e.g., matrix M_{C}) corresponding to an n-qubit Clifford unitary.

At block 1704, the Clifford synthesis algorithm 130 is configured to determine a first symplectic matrix (e.g., symplectic matrix F₁) that transforms the first involution matrix (e.g., involution M₁) into a first form aligned to a first form matrix (e.g., matrix A₁′), where a first Clifford unitary B1 matrix is equal to the first symplectic matrix (e.g., symplectic matrix F₁).

At block 1706, the Clifford synthesis algorithm 130 is configured to determine a second symplectic matrix (e.g., symplectic matrix F₂) that transforms the second involution matrix (e.g., involution M₂) into a second form aligned to a second form matrix (e.g., matrix A₂′) where a second Clifford unitary B2 matrix is equal to the second symplectic matrix (e.g., symplectic matrix F₂).

At block 1708, the Clifford synthesis algorithm 130 is configured to, in response to the first form matrix (e.g., matrix A₁′) failing to be a diagonal matrix, set a second k number to half a first size of the first form matrix (e.g., matrix A₁′) and set a second sequence (e.g., sequence s₂) to include the second k number of CZ gates (e.g., CZ gate circuits 904), where the second k number is about half a number n.

At block 1710, in response to the second form matrix being a diagonal matrix, the Clifford synthesis algorithm 130 is configured to set a first k number to a second size of the second form matrix and set a first sequence (e.g., sequence s₁) to include the first k number of S gates (e.g., S gate circuits 902), where the first k number is less than or equal to the number n.

At block 1712, the Clifford synthesis algorithm 130 is configured to add a Pauli unitary P (e.g., Pauli unitary P 1502) subsequent to the first sequence and the second sequence.

At block 1714, the Clifford synthesis algorithm 130 is configured to cause execution of the first sequence (e.g., sequence s₁), the second sequence (e.g., sequence s₂), and the Pauli unitary P (e.g., Pauli unitary P 1502) on the quantum computer 10.

In one or more embodiments, the execution of the first sequence, the second sequence, and the Pauli unitary P on the quantum computer has the same effect as executing the n-qubit Clifford unitary and changes states of the qubits in the same way as the n-qubit Clifford unitary. The execution of the first sequence is implemented using (or by causing) mutually-commuting measurements of the quantum computer 10. The execution of the second sequence is implemented using (or by causing) mutually-commuting measurements of the quantum computer. The number n is a number of logical qubits (e.g., formed of one or more physical qubits 14) utilized to store data to execute the n-qubit Clifford unitary. The first sequence and the second sequence each require at most the n number of measurements, for example, for each element is the series.

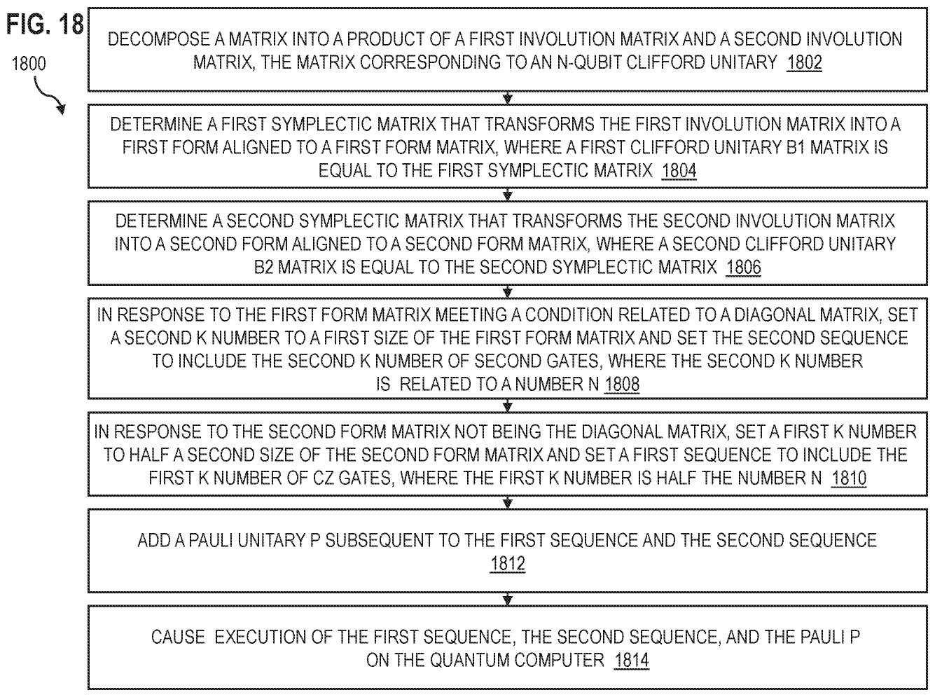

FIG. 18 is a flowchart of a computer-implemented method 1800 for operating a quantum computer, by performing Clifford unitary synthesis via generalized phase gate (S) and controlled-Z (CZ) gates to execute a Clifford unitary on the quantum computer. Reference can be made to any of the figures discussed herein.

At block 1802, the Clifford synthesis algorithm 130 of the classical computer 100 is configured to decompose a matrix (e.g., matrix M_{C}) into a product of a first involution matrix (e.g., involution M₁) and a second involution matrix (e.g., involution M₂), the matrix (e.g., matrix M_{C}) corresponding to an n-qubit Clifford unitary.

At block 1804, the Clifford synthesis algorithm 130 is configured to determine a first symplectic matrix (e.g., symplectic matrix F₁) that transforms the first involution matrix (e.g., involution M₁) into a first form aligned to a first form matrix (e.g., matrices A₁′), where a first Clifford unitary B1 matrix is equal to the first symplectic matrix (e.g., symplectic matrix F₁).

At block 1806, the Clifford synthesis algorithm 130 is configured to determine a second symplectic matrix (e.g., symplectic matrix F₂) that transforms the second involution matrix (e.g., involution M₂) into a second form aligned to a second form matrix (e.g., matrix A₂′), where a second Clifford unitary B2 matrix is equal to the second symplectic matrix (e.g., symplectic matrix F₂).

At block 1808, the Clifford synthesis algorithm 130 is configured to, in response to the first form matrix (e.g., matrix A₁′) meeting a condition related to a diagonal matrix, setting a second k number to a first size of the first form matrix (e.g., matrix A₁′) and setting the second sequence (e.g., sequence s₂) to include the second k number of second gates, where the second k number is related to a number n.

At block 1810, the Clifford synthesis algorithm 130 is configured to, in response to the second form matrix (e.g., matrix A₂′) not being the diagonal matrix, set a first k number to half a second size of the second form matrix (e.g., matrix A₂′) and set a first sequence (e.g., sequence s₁) to include the first k number of CZ gates, where the first k number is half the number n.

At block 1812, the Clifford synthesis algorithm 130 is configured to add a Pauli unitary P (e.g., Pauli unitary P 1502) subsequent to the first sequence and the second sequence.

At block 1814, the Clifford synthesis algorithm 130 is configured to cause execution of the first sequence (e.g., sequence s₁), the second sequence (e.g., sequence s₂), and the Pauli unitary P (e.g., Pauli unitary P 1502) on the quantum computer 10.

In one or more embodiments, the first form matrix (e.g., matrix A₁′) meeting the condition related to the diagonal matrix comprises the first form matrix (e.g., matrix A₁′) being the diagonal matrix; in response to the first form matrix (e.g., matrix A₁′) being the diagonal matrix, the second gates are S gates (e.g., S gate circuits 902) and the second k number is less than or equal to the number n. In one or more embodiments, the first form matrix (e.g., matrix A₁′) meeting the condition related to the diagonal matrix comprises the first form matrix (e.g., matrix A₁′) failing to be the diagonal matrix; in response to the first form matrix (e.g., matrix A₁′) failing to be the diagonal matrix, the second gates are CZ gates (e.g., CZ gate circuits 904) and the second k number is about half the number n.

In one or more embodiments, the Clifford synthesis algorithm 130 is configured to receive, from the quantum computer 10, output of a first value (e.g., a result of one or more measurements) for the first sequence, a second value (e.g., a result of one or more measurements) for the second sequence, and a third value (e.g., a result of one or more measurements) for the Pauli unitary P. The execution of the first sequence, the second sequence, and the Pauli unitary P on the on the quantum computer 10 generates an output for the n-qubit Clifford unitary. The execution of the first sequence is implemented using (or by causing) mutually-commuting measurements of the quantum computer 10.

Turning now to FIG. 19, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 19 the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 19.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 19, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 19 is not intended to indicate that the computer system 100 is to include all of the components shown in FIG. 19. Rather, the computer system 100 can include any appropriate fewer or additional components not illustrated in FIG. 19 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

While the disclosure has been described with reference to various embodiments, it will be understood by those skilled in the art that changes may be made and equivalents may be substituted for elements thereof without departing from its scope. The various tasks and process steps described herein can be incorporated into a more comprehensive procedure or process having additional steps or functionality not described in detail herein. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

Unless defined otherwise, technical and scientific terms used herein have the same meaning as is commonly understood by one of skill in the art to which this disclosure belongs.

Various embodiments of the invention are described herein with reference to the related drawings. The drawings depicted herein are illustrative. There can be many variations to the diagrams and/or the steps (or operations) described therein without departing from the spirit of the disclosure. For instance, the actions can be performed in a differing order or actions can be added, deleted or modified. All of these variations are considered a part of the present disclosure.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof. The term “or” means “and/or” unless clearly indicated otherwise by context.

The terms “received from”, “receiving from”, “passed to”, “passing to”, etc. describe a communication path between two elements and does not imply a direct connection between the elements with no intervening elements/connections therebetween unless specified. A respective communication path can be a direct or indirect communication path.

The corresponding structures, materials, acts, and equivalents of all means or step plus function elements in the claims below are intended to include any structure, material, or act for performing the function in combination with other claimed elements as specifically claimed.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

The present invention may be a system, a method, and/or a computer program product at any possible technical detail level of integration. The computer program product may include a computer readable storage medium (or media) having computer readable program instructions thereon for causing a processor to carry out aspects of the present invention.

Various embodiments are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments described herein have been presented for purposes of illustration, but are not intended to be exhaustive or limited to the form(s) disclosed. The embodiments were chosen and described in order to best explain the principles of the disclosure. Many modifications and variations will be apparent to those of ordinary skill in the art without departing from the scope and spirit of the described embodiments. The terminology used herein was chosen to best explain the principles of the various embodiments, the practical application or technical improvement over technologies found in the marketplace, or to enable others of ordinary skill in the art to understand the embodiments described herein.

What is claimed is:

1. A method for operating a quantum computer, the method comprising:
decomposing a matrix into a product of a first involution matrix and a second involution matrix, the matrix corresponding to an n-qubit Clifford unitary;
determining a first symplectic matrix that transforms the first involution matrix into a first form aligned to a first form matrix, wherein a first Clifford unitary matrix is described by the first symplectic matrix;
determining a second symplectic matrix that transforms the second involution matrix into a second form aligned to a second form matrix wherein a second Clifford unitary matrix is described by the second symplectic matrix;
in response to the first form matrix being a diagonal matrix, setting a second k number to a first size of the first form matrix and setting a second sequence to include the second k number of generalized S gates, wherein the second k number is less than or equal to a number n;
in response to the second form matrix being the diagonal matrix, setting a first k number to a second size of the second form matrix and setting a first sequence to include the first k number of generalized S gates, wherein the first k number is less than or equal to the number n;
adding a Pauli unitary P subsequent to the first sequence and the second sequence; and
causing execution of the first sequence, the second sequence, and the Pauli unitary P on the quantum computer.

2. The method of claim 1, wherein the generalized S gates in the first sequence are determined by the second Clifford unitary matrix and the generalized S gates in the second sequence are determined by the first Clifford unitary matrix.

3. The method of claim 1, wherein the execution of the first sequence, the second sequence, and the Pauli unitary P on the quantum computer has a same effect as executing the n-qubit Clifford unitary.

4. The method of claim 1, wherein the execution of the first sequence is implemented using mutually-commuting measurements of the quantum computer.

5. The method of claim 1, wherein the execution of the second sequence is implemented using mutually-commuting measurements of the quantum computer.

6. The method of claim 1, wherein the number n is at most a number of logical qubits utilized to store data.

7. The method of claim 1, wherein the first sequence and the second sequence each require at most the n number of measurements.

8. A method for operating a quantum computer, the method comprising:
decomposing a matrix into a product of a first involution matrix and a second involution matrix, the matrix corresponding to an n-qubit Clifford unitary;
determining a first symplectic matrix that transforms the first involution matrix into a first form aligned to a first form matrix, wherein a first Clifford unitary matrix is described by the first symplectic matrix;
determining a second symplectic matrix that transforms the second involution matrix into a second form aligned to a second form matrix wherein a second Clifford unitary matrix is described by the second symplectic matrix;
in response to the first form matrix failing to be a diagonal matrix, setting a second k number to half a first size of the first form matrix and setting a second sequence to include the second k number of generalized CZ gates, wherein the second k number is about half a number n;
in response to the second form matrix being the diagonal matrix, setting a first k number to a second size of the second form matrix and setting a first sequence to include the first k number of generalized S gates, wherein the first k number is less than or equal to the number n;
adding a Pauli unitary P subsequent to the first sequence and the second sequence; and
causing execution of the first sequence, the second sequence, and the Pauli unitary P on the quantum computer.

9. The method of claim 8, wherein the generalized S gates in the first sequence are determined by the second Clifford unitary matrix and the generalized CZ gates in the second sequence are determined by the first Clifford unitary matrix.

10. The method of claim 8, wherein the execution of the first sequence, the second sequence, and the Pauli unitary P on the quantum computer has a same effect as executing the n-qubit Clifford unitary.

11. The method of claim 8, wherein the execution of the first sequence is implemented using mutually-commuting measurements of the quantum computer.

12. The method of claim 8, wherein the execution of the second sequence is implemented using mutually-commuting measurements of the quantum computer.

13. The method of claim 8, wherein the number n is at most a number of logical qubits utilized to store data.

14. The method of claim 8, wherein the first sequence and the second sequence each require at most the n number of measurements.

15. A method for operating a quantum computer, the method comprising:
decomposing a matrix into a product of a first involution matrix and a second involution matrix, the matrix corresponding to an n-qubit Clifford unitary;
determining a first symplectic matrix that transforms the first involution matrix into a first form aligned to a first form matrix, wherein a first Clifford unitary matrix is described by the first symplectic matrix;
determining a second symplectic matrix that transforms the second involution matrix into a second form aligned to a second form matrix, wherein a second Clifford unitary matrix is described by the second symplectic matrix;
in response to the first form matrix meeting a condition related to a diagonal matrix, setting a second k number to a first size of the first form matrix and setting a second sequence to include the second k number of second gates, wherein the second k number is related to a number n;
in response to the second form matrix not being the diagonal matrix, setting a first k number to half a second size of the second form matrix and setting a first sequence to include the first k number of generalized CZ gates, wherein the first k number is half the number n;
adding a Pauli unitary P subsequent to the first sequence and the second sequence; and
causing execution of the first sequence, the second sequence, and the Pauli unitary P on the quantum computer.

16. The method of claim 15, wherein:
the first form matrix meeting the condition related to the diagonal matrix comprises the first form matrix being the diagonal matrix; and
in response to the first form matrix being the diagonal matrix, the second gates comprise generalized S gates and the second k number is less than or equal to the number n.

17. The method of claim 15, wherein:
the first form matrix meeting the condition related to the diagonal matrix comprises the first form matrix failing to be the diagonal matrix; and
in response to the first form matrix failing to be the diagonal matrix, the second gates comprise generalized CZ gates and the second k number is about half the number n.

18. The method of claim 15, wherein generalized S gates or the generalized CZ gates in the first sequence are determined by the second Clifford unitary matrix and the generalized S gates in the second sequence are determined by the first Clifford unitary matrix.

19. The method of claim 15, wherein the execution of the first sequence, the second sequence, and the Pauli unitary P on the on the quantum computer has a same effect as executing the n-qubit Clifford unitary.

20. The method of claim 15, wherein the execution of the first sequence is implemented using mutually-commuting measurements of the quantum computer.
